(19) United States
(12) Patent Application Publication
(10) Pub. No.: US 2021/0022355 A1
(43) Pub. Date: Jan. 28, 2021

(54) FROZEN SUSHI SET

(71) Applicant: SHARP KABUSHIKI KAISHA, Sakai City, Osaka (JP)

(72) Inventors: MISATO ASHIE, Sakai City, Osaka (JP); AKIO IIJIMA, Sakai City, Osaka (JP); ATSUTADA FUKUMORI, Sakai City, Osaka (JP); YOSHINOBU TOMOMURA, Sakai City, Osaka (JP); MASAKI OHTSUKA, Sakai City, Osaka (JP)

(21) Appl. No.: 17/043,957

(22) PCT Filed: Jun. 6, 2019
(86) PCT No.: PCT/JP2019/022440

§ 371 Date: Sep. 30, 2020

(30) Foreign Application Priority Data
Jun. 13, 2018 (JP) 2018-112975

(51) Int. Cl. A23B 4/06; A23L 17/00

(52) U.S. Cl. CPC A23B 4/06; A23V 2002/00; A23L 17/00

(57) ABSTRACT

A frozen sushi pack includes: a container; and a plurality of sushi pieces arranged in the container. Each of the sushi pieces includes: a shari rice base; and a neta topping. Using a water content per unit volume ranging from 55% to 65% as a reference value, the sushi pieces in the container are classified into: first sushi pieces of a first group in which the neta topping contains a water content below the reference value; and second sushi pieces of a second group in which the neta topping contains a water content equal to the reference value or above.

### TECHNICAL FIELD

The present invention relates to a frozen sushi set including a plurality of sushi pieces to be defrosted when served.

### BACKGROUND ART

Recent revolutions in freezing technologies such as freezing and refrigeration management and freshness-maintenance techniques have revolutionized food distribution systems. Thanks to these technological revolutions and transition to more globalized societies, a wider variety of foods have become available, and increasing number of people are paying attention to such foods. Accordingly, high-end foods are in high demand, and such restaurants as circulating sushi eateries featuring fresh food have started to open.

In order to meet consumers' great interests in and demands for foods, required is an improvement in defrosting techniques, along with advancement in freezing and refrigeration techniques.

Patent Document 1, for example, discloses a high-frequency heating apparatus to be used for defrosting frozen sushi. This high-frequency heating apparatus uses microwaves. In the high-frequency heating apparatus, frozen sushi pieces are placed in accordance with distribution of the microwaves for reducing the risk that the frozen sushi would be unevenly heated. Furthermore, the frozen sushi pieces are placed on a turntable, so that the rotating turntable reduces unevenness in heating among the frozen sushi pieces.

Moreover, frozen sushi pieces disclosed in Patent Document 2 are arranged in accordance with distribution of microwaves in heating with a microwave oven. Such an arrangement contributes to reducing the risk of uneven heating.

In addition, Patent Document 3 discloses a method for defrosting frozen sushi. In the method, a container (a magnetic shield material) containing water is placed on top of the sushi container. Taking advantage of the fact that water is heated up before ice, the method adjusts the temperature of the frozen sushi in defrosting.

### CITATION LIST

### Patent Literature

[Patent Document 1] Japanese Unexamined Patent Application Publication No. H10-210960

[Patent Document 2] Japanese Unexamined Patent Application Publication No. H10-290673

[Patent Document 3] Japanese Unexamined Patent Application Publication No. H10-056995

### SUMMARY OF INVENTION

### Technical Problem

Advancement in freezing and refrigerating techniques makes it possible to preserve food for a long time period. Still, defrosting techniques in finishing stage often determine ultimate deliciousness of food. Current defrosting techniques, however, cause such problems as excessive heating and deterioration in texture. Furthermore, some foods are not suitable for defrosting. These problems relatively narrow choices of foods, failing to sufficiently satisfy consumers with the foods they crave for. As can be seen, the defrosting techniques fall behind in advancement of the freezing and refrigerating techniques. At this moment, no satisfactory defrosting technique is commonly available.

In particular, when a sushi set including frozen sushi with two or more kinds of neta toppings is dielectrically heated and defrosted, the temperature rises unevenly depending on the kinds of the neta toppings. Hence, the sushi set cannot be uniformly defrosted. Such neta toppings containing a high proportion of water such as squid and scallop are harder to warm; whereas, neta toppings containing a low proportion of water such as salmon roe, fatty tuna cut, and vinegared mackerel are easier to warm. The problem with the heating is that when squid is still frozen, fatty tuna cut develops a burn.

Therefore, the present invention provides a frozen sushi set capable of maintaining excellent texture and quality when defrosted by dielectric heating.

### Solution to Problem

A frozen sushi set according to an aspect of the present invention includes: a container; and a plurality of sushi pieces arranged in the container, wherein each of the sushi pieces includes: a shari rice base, and a neta topping, and, using a water content per unit volume ranging from 55% to 65% as a reference value, the sushi pieces are classified into: a first group in which the neta topping contains a water content below the reference value; and a second group in which the neta topping contains a water content equal to the reference value or above.

In the frozen sushi set according to an aspect of the present invention, the sushi pieces classified into the second group may be arranged closer to an end of the container.

In the frozen sushi set according to an aspect of the present invention, the neta topping may include at least two kinds of neta toppings each having a different water content per unit volume, the at least two kinds of neta toppings may include: a first neta topping a water content per unit volume of which is low; and a second neta topping a water content per unit volume of which is high, and when a front-rear direction and a left-right direction of the frozen sushi set in a horizontal plane are defined, second sushi pieces each having the second neta topping may be arranged next to first sushi pieces each having the first neta topping, while the second sushi pieces may be positioned in at least two of four neighboring positions including front, rear, left, and right of each of the first sushi pieces, the first sushi pieces and the second sushi pieces being included in the sushi pieces.

In the frozen sushi set according to an aspect of the present invention, the sushi pieces classified into the first group and the sushi pieces classified into the second group may be alternately arranged in the container.

In the frozen sushi set according to an aspect of the present invention, the sushi pieces classified into the first group may account for 25% to 75% of all the sushi pieces included in the frozen sushi set.

In the frozen sushi set according to an aspect of the present invention, the neta topping for each of the sushi pieces classified into the first group may be larger in amount than the neta topping for each of the sushi pieces classified into the second group.

In the frozen sushi set according to an aspect of the present invention, the neta topping for each of the sushi pieces classified into the first group may be taller than the neta topping for each of the sushi pieces classified into the second group.

The frozen sushi set according to an aspect of the present invention may be defrosted by dielectric heating with a high-frequency electric field of HF waves or VHF waves.

### Advantageous Effects of Invention

As can be seen, when defrosted by dielectric heating with a high-frequency electric field of HF waves or VHF waves, a frozen sushi set according to an aspect of the present invention can reduce the risks of uneven and excessive heating. When defrosted, the frozen sushi set according to an aspect of the present invention maintains excellent texture and quality. Hence, the frozen sushi set is highly satisfactory to consumers.

### BRIEF DESCRIPTION OF DRAWINGS

FIG. 1 is a schematic view illustrating an appearance of a high-frequency heating apparatus according to a first embodiment.

FIG. 2 is a schematic view illustrating an internal configuration of the high-frequency heating apparatus in FIG. 1.

FIG. 3 is a schematic view illustrating a circuitry configuration in the high-frequency heating apparatus in FIG. 1.

FIG. 4 is a graph illustrating a relationship between a ratio of a height of a product to be defrosted (a product to be heated) to an inter-electrode distance and an energy rate for portions of the product.

FIG. 5(a) and FIG. 5(b) are schematic views illustrating a relationship between a height H of a product A to be heated and an inter-electrode distance D.

FIG. 6 is a graph illustrating a rate of a voltage between the electrodes when the height H of the product A varies.

FIG. 7 is a graph illustrating a rate of a voltage between the electrodes when the height H of the product A varies.

FIG. 8 is a table showing an evaluation result obtained when various products A are defrosted, changing the inter-electrode distance D.

FIG. 9 is a schematic view illustrating spaces to be defined when the product A to be defrosted is placed in a heating chamber of the high-frequency heating apparatus.

FIG. 10 is a schematic view illustrating the spaces in FIG. 9 in the form of capacitors as an equivalent circuit.

FIG. 11 is a graph illustrating a change in an “all current/product-to-be-defrosted current” with respect to an “electrode area/product-to-be-defrosted base area (n)” when a high-frequency voltage is applied to the high-frequency heating apparatus illustrated in FIG. 9.

FIG. 12 is a graph illustrating a change in the “all current/product-to-be-defrosted current” with respect to the “electrode area/product-to-be-defrosted base area (n)” when a high-frequency voltage is applied to the high-frequency heating apparatus illustrated in FIG. 9.

FIG. 13 is a table showing a ratio of wiring power loss observed when food products are defrosted by high-frequency heating apparatuses each having a different electrode area.

FIG. 14 is a table showing the “all current/product-to-be-defrosted current” observed when food products are defrosted by high-frequency heating apparatuses each having a different electrode area.

FIG. 15 is a schematic view illustrating an internal configuration of a high-frequency heating apparatus according to a second embodiment.

FIG. 16 is a schematic view illustrating a circuitry configuration in the high-frequency heating apparatus according to the second embodiment.

FIG. 17 is a schematic view illustrating a frozen food product (a frozen sushi piece) according to a third embodiment.

FIG. 18 is a graph illustrating a temperature rise by defrosting a product to be heated with an electric field of VHF waves or HF waves when an upper layer is higher in water content than a lower layer.

FIG. 19 is a graph illustrating a temperature rise by defrosting a product to be heated with an electric field of VHF waves or H F waves when an upper layer is lower in water content than a lower layer.

FIG. 20 is a table showing water contents (proportion of water in %) included in ingredients of various sushi pieces in a sushi pack.

FIG. 21 is a schematic view illustrating other examples of the frozen food product according to the third embodiment.

FIG. 22 is a schematic view illustrating steps of a method for producing a food product according to a fourth embodiment.

FIG. 23 is a graph illustrating a variation in temperature (a freezing curve) in quick freezing and slow freezing.

FIG. 24 is a schematic side view illustrating an example of a frozen sushi pack according to a fifth embodiment.

FIG. 25 is a schematic side view illustrating another example of the frozen sushi pack according to the fifth embodiment.

FIG. 26 is a schematic top view illustrating an example of an arrangement of sushi pieces in the frozen sushi pack according to the fifth embodiment.

FIG. 27 is a schematic top view illustrating an example of an arrangement of sushi pieces in the frozen sushi pack according to the fifth embodiment.

FIG. 28 is a schematic top view illustrating an example of an arrangement of sushi pieces in a frozen sushi pack according to a sixth embodiment.

FIG. 29 is a schematic top view illustrating an example of an arrangement of the sushi pieces in the frozen sushi pack according to the fifth and sixth embodiments.

FIG. 30 is a schematic top view illustrating an example of an arrangement of the sushi pieces in the frozen sushi pack according to the fifth and sixth embodiments.

FIG. 31 is a schematic top view illustrating an example of an arrangement of the sushi pieces in the frozen sushi pack according to the fifth embodiment.

FIG. 32 is a graph illustrating a relationship between a total water content (g) of neta toppings of the sushi pieces in a frozen sushi pack and a product of a defrosting time period and a defrosting power (time period×W).

FIG. 33 is a schematic side view illustrating a frozen sushi pack according to a modification of the fifth embodiment.

FIG. 34 is a schematic side view illustrating a frozen sushi pack according to a modification of the fifth embodiment.

FIG. 35 is a schematic side view illustrating a frozen sushi pack according to a modification of the fifth embodiment.

FIG. 36 is a schematic view illustrating uneven temperature distribution caused in defrosting by a difference in height of products to be heated.

FIG. 37 is a schematic side view illustrating an example of a frozen sushi pack according to the sixth embodiment.

FIG. 38 is a schematic top view illustrating an example of the frozen sushi pack in FIG. 37.

FIG. 39 is a schematic top view illustrating an example of an arrangement of sushi pieces in the frozen sushi pack according to the sixth embodiment.

FIG. 40 is a schematic top view illustrating an example of an arrangement of the sushi pieces in the frozen sushi pack according to the sixth embodiment.

FIG. 41 is a schematic view illustrating uneven temperature distribution caused inside a product to be heated in defrosting.

FIG. 42 is a schematic top view illustrating an example of an arrangement of the sushi pieces in the frozen sushi pack according to the sixth embodiment.

FIG. 43 is a schematic top view illustrating an example of an arrangement of the sushi pieces in the frozen sushi pack according to the sixth embodiment.

FIG. 44 is a schematic top view illustrating an example of an arrangement of the sushi pieces in the frozen sushi pack according to the sixth embodiment.

FIG. 45 is a schematic view illustrating how a product to be heated with a height d is defrosted, using electrodes with an inter-electrode distance D.

FIG. 46 is a circuit diagram of an equivalent circuit of a configuration in FIG. 45.

FIG. 47 is a graph illustrating a relationship between a greatest height (cm) and an energy rate of a sushi piece.

FIG. 48 is a schematic view illustrating a relationship between a greatest height (dmax) and a smallest height (dmin) among sushi pieces.

FIG. 49 is a graph illustrating a relationship between a height (cm) and an energy rate of a sushi piece.

### DESCRIPTION OF EMBODIMENTS

Described below are embodiments of the present invention, with reference to the drawings. Like reference signs designate identical or corresponding components throughout the descriptions below. These components share the same names and functions. Such components will not be repeatedly elaborated upon.

### First Embodiment

Schematic Configuration of High-Frequency Heating Apparatus

Described in this embodiment is a high-frequency heating apparatus 100 as an example of a dielectric heating apparatus according to the present invention. The high-frequency heating apparatus 100 is suitable for use in small spaces, in which large machinery cannot be installed, including retail stores such as convenience stores, restaurant kitchens, and home kitchens.

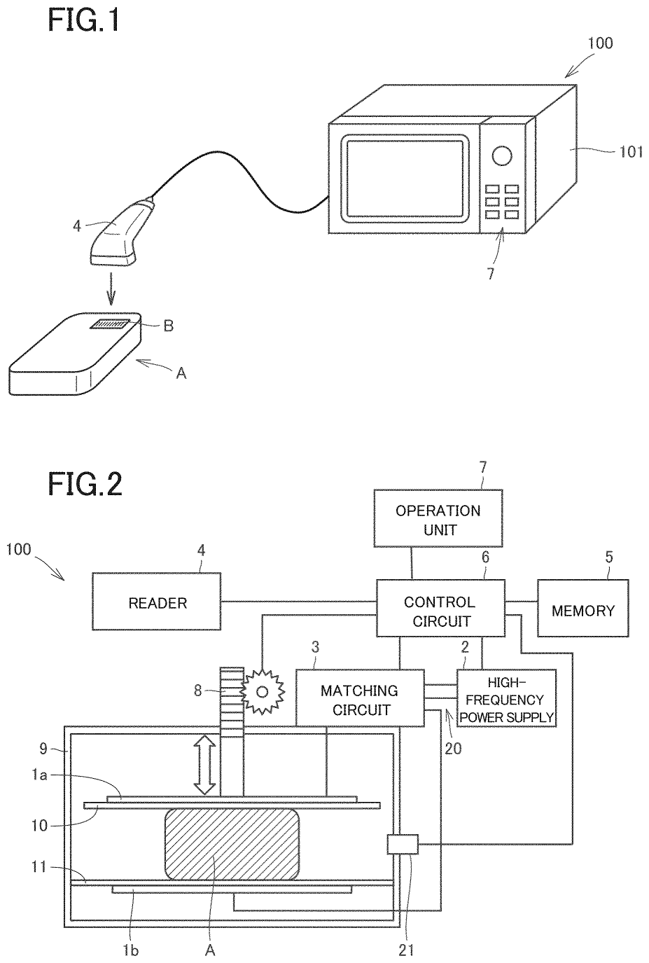

Described first is a schematic configuration of the high-frequency heating apparatus 100 according to this embodiment, with reference to FIGS. 1 and 2. FIG. 1 shows an appearance of the high-frequency heating apparatus 100. FIG. 2 shows an internal configuration of the high-frequency heating apparatus 100.

As illustrated in FIG. 1, the high-frequency heating apparatus 100 mainly includes: a body 101; and a reader 4 connected to the body 101. In this embodiment, the reader 4 functions as a determiner determining, for example, a kind and a size of a product A to be heated (or to be defrosted) with the high-frequency heating apparatus 100. An example of the reader 4 includes a bar-code reader. An example of the product A includes a product (e.g., frozen food and refrigerated food) to be sold at convenience stores and supermarkets. Attached to the product A is a bar code B readable with the reader 4.

The high-frequency heating apparatus 100 of this embodiment applies a high-frequency electric field to the product A to defrost and heat the product A. The high-frequency heating apparatus 100 includes a heating chamber (a defrosting chamber) 9. The heating chamber 9 is formed of a metal casing.

As illustrated in FIG. 2, the heating chamber 9 includes therein: an upper electrode 1a; a lower electrode 1b; a movable unit (a position changing mechanism) 8; a top face plate 10; a bottom face plate 11; and a radiant heat sensor 21. The upper electrode 1a and the lower electrode 1b are electrode plates of the high-frequency heating apparatus 100. The upper electrode 1a and the lower electrode 1b are arranged in parallel with each other. The upper electrode 1a, the lower electrode 1b, the top face plate 10, and the bottom face plate 11 are all flat plates. The top face plate 10 is disposed below the upper electrode 1a. The bottom face plate 11 is disposed above the lower electrode 1b.

The upper electrode 1a is bonded and fastened to an upper face of the top face plate 10. Moreover, the upper electrode 1a is coupled to the movable unit 8. The upper electrode 1a is supported, by the movable unit 8, to be positioned in an upper part inside the heating chamber 9.

The movable unit 8 includes such components as a gear and a motor. These components, connected to a control circuit 6 through wiring, can vertically move the upper electrode 1a and the top face plate 10. Such a feature makes it possible to change the position of the upper electrode 1a during heating, depending on the size of the product A. That is, the feature makes it possible to change a clearance between the upper electrode 1a and the lower electrode 1b. Hence, the movable unit 8 functions as a position changing mechanism (also referred to as a height changing mechanism) to change the position (the height) of an electrode plate (the upper electrode 1a in this embodiment).

The upper electrode 1a and the lower electrode 1b are connected through wiring to a voltage applicator 20 (specifically, a matching circuit 3). Such a feature provides a high-frequency electric field between the upper electrode 1a and the lower electrode 1b.

The bottom face plate 11 is fastened to a side wall of the heating chamber 9. To a lower face of the bottom face plate 11, the lower electrode 1b is bonded and fastened. Hence, in this embodiment, the bottom face plate 11 and the lower electrode 1b are stationary inside the heating chamber 9.

In heating or defrosting the product A with the high-frequency heating apparatus 100, the product A is placed on the bottom face plate 11. After that, a high-frequency electric field is provided between the upper electrode a and the lower electrode 1b, so that the product A is dielectrically heated and defrosted by dielectric loss.

Note that, in this embodiment, the movable unit 8 connected to the upper electrode 1a vertically moves the upper electrode 1a, making it possible to change the height of the upper electrode 1a. Such a feature can change the clearance between the upper electrode 1a and the lower electrode 1b, depending on the size of the product A to be placed on the bottom face plate 11.

When the product A is relatively small, the upper electrode 1a can be positioned low so that the product A and the upper electrode 1a are close to each other, making it possible to efficiently heat the product A. Meanwhile, when the product A is relatively large, the upper electrode 1a can be positioned high so that the product A and the upper electrode 1a are not in contact with each other. Such a feature makes it possible to efficiently heat the product A in a relatively large size.

The radiant heat sensor 21 is disposed to a side wall inside the heating chamber 9. Specifically, the radiant heat sensor 21 is disposed (i) near a position in which the product A on the bottom face plate 11 is placed, and (ii) out of an area in which the upper electrode 1a and the lower electrode 1b are installed. The radiant heat sensor 21 detects a temperature on a surface of the product A. The radiant heat sensor 21 is connected to the control circuit 6 inside the voltage applicator 20. The control circuit 6 receives a result of the detection by the radiant heat sensor 21. In this embodiment, the radiant heat sensor 21 can determine how well the product A is heated (defrosted).

Furthermore, as illustrated in FIG. 2, the high-frequency heating apparatus 100 includes outside the heating chamber 9: the voltage applicator 20; the control circuit (the controller) 6; the reader 4; an operation unit (an input unit) 7; and a memory 5. The voltage applicator 20 applies a high-frequency voltage between the upper electrode a and the lower electrode 1b. The voltage applicator 20 includes such main features as: a high-frequency power supply 2; and the matching circuit 3. A specific configuration of the voltage applicator 20 will be described later.

The control circuit 6 is connected to, and controls, the constituent features in the high-frequency heating apparatus 100. For example, the control circuit 6 is connected to, and controls the operation of, the movable unit 8.

Moreover, other than the movable unit 8, the control circuit 6 is connected through wiring to the high-frequency power supply 2 and the matching circuit 3. The control circuit 6 controls output of the high-frequency power supply 2 and impedance of the matching circuit 3, so that the product A can be efficiently heated.

Moreover, the control circuit 6 is connected through wiring also to the reader 4 and the memory (a storage unit) 5. The control circuit 6 matches data stored in the memory 5 to information, on the product A, read by the reader 4, and sets the optimum control condition for the product A, so that the product A can be efficiently heated.

The memory 5 includes a read-only memory (ROM), and a random-access memory (RAM). The memory 5 stores an operation program of, and setting data for, the high-frequency heating apparatus 100. Moreover, the memory 5 is connected to the control circuit 6, and temporarily stores a result of calculation by the control circuit 6. Furthermore, in this embodiment, the memory 5 stores a kind of the product A and data of the product A for optimum control condition.

The memory 5 stores, for example, a distance between the electrodes and a capacitance of variable capacitors 3a and 3b as control information to be determined on the basis of identification information, on the product A, to be obtained by the reader 4. Note that the memory 5 may store control information other than the above one. Examples of other control information include output power and a drive time period (a heating time period) of the high-frequency power supply 2.

The voltage applicator 20 and the memory 5 are disposed in the body 101. Meanwhile, the reader 4 is disposed out of the body 101. The reader 4 is connected through a line to the body 101 (specifically, to the control circuit 6).

The reader 4 can determine what the product A is like (e.g., a kind, a size, a weight, and a water content of the product A). An example of the reader 4 includes a bar-code reader, a radio-frequency (RF) identification tag reader, or an image identification apparatus.

The operation unit 7 is disposed, for example, on the front face of the body 101 (see FIG. 1). The operation unit 7 includes operation buttons to input: a kind, a size, a weight, and an a water content of the product A; a heating time period (a defrosting time period) for the product A. and an output power for heating the product A. Thanks to this operation unit 7, the user can not only read the bar code B on the product A with the reader 4, but also manually set the kind of, and the heating time period (the defrosting time period) for, the product A, and the output power for heating the product A.

As can be seen, the high-frequency heating apparatus 100 according to this embodiment includes: the reader 4 reading, for example, the kind and the size of the product A; the memory 5 storing the product A in association with the control information on heating the product A; and the control circuit 6 changing the heating time period and the output power on the basis of the control information associated with the product A determined by the reader 4.

Moreover, other than the above constituent features, the high-frequency heating apparatus 100 according to this embodiment may include a weight sensor to measure how much the product A weighs. The weight sensor is connected to the control circuit 6 inside the voltage applicator 20. Transmitted to the control circuit 6 is information on the weight of the product A measured by the weight sensor. Such a feature allows the control circuit 6 to change the heating time period (the defrosting time period) and the output power (an output wattage rating), reflecting the weight information to be transmitted from the weight sensor, in addition to information on the kind of the product A to be transmitted from the reader 4 and the operation unit 7.

Note that, as an example, the two electrodes (i.e., the upper electrode 1a and the lower electrode 1b) in this embodiment face each other inside the heating chamber 9. Alternatively, in another embodiment of the present invention, the two electrodes face each other out of the heating chamber. Moreover, either one of the two electrodes (e.g., the upper electrode and the lower electrode) may be a part of the casing of the heating chamber made of metal.

Configuration of Voltage Applicator

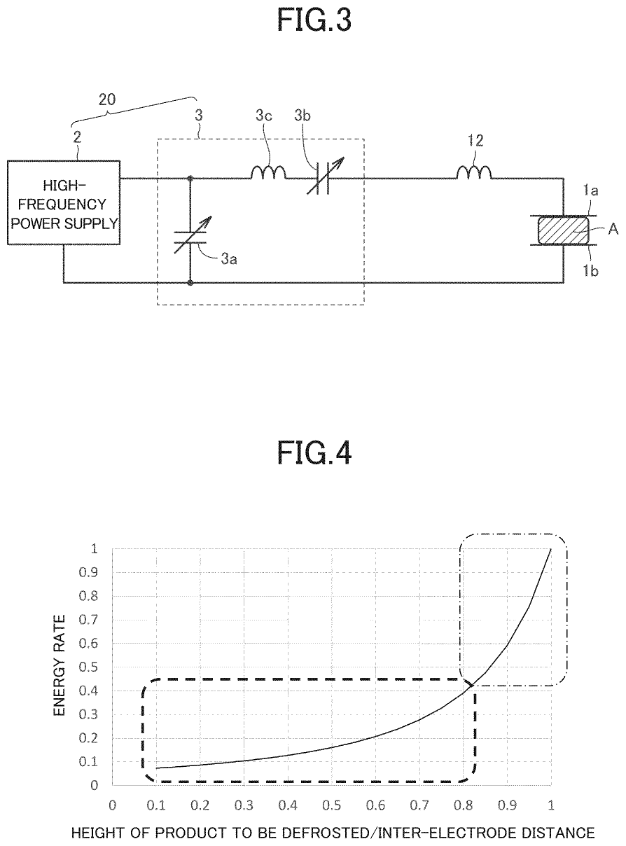

Described next is a configuration of the voltage applicator 20 to apply a voltage to the electrodes in the heating chamber 9, with reference to FIGS. 2 and 3. FIG. 3 is a circuit diagram illustrating a circuitry configuration between (i) the electrodes 1a and 1b and (ii) the high-frequency power supply 2.

The voltage applicator 20 applies a high-frequency voltage between the upper electrode 1a and the lower electrode 1b. The voltage applicator 20 includes such main features as: the high-frequency power supply 2; and the matching circuit 3.

The high-frequency power supply 2 transmits a voltage signal whose frequency ranges from a high frequency (HF) band to a very high frequency (VHF) band. Here, the HF band is a frequency band ranging from 3 to 30 MHz. The VHF band is a frequency band ranging from 30 to 300 MHz. The voltage signal transmitted from the high-frequency power supply 2 is amplified by an amplifier (not shown) to a desired power. The amplified voltage signal is transmitted to the matching circuit 3.

As illustrated in FIG. 3, the matching circuit 3 includes: the variable capacitors (variable reactance elements) 3a and 3b; and a coil 3c. Hence, the matching circuit 3 offsets reactance of a capacitor including the upper electrode 1a and the lower electrode 1b. Moreover, the matching circuit 3 adjusts values of the variable capacitors 3a and 3b, making it possible to match an input impedance in the matching circuit 3 to an output impedance in the amplifier. Such a feature makes it possible to efficiently apply a high-frequency electric field to the product A.

Between the variable capacitor 3b of the matching circuit 3 and the upper electrode a, a coil 12 is disposed. The coil 12 functions as an inductor, together with the matching circuit 3, for impedance matching in the circuit of the high-frequency heating apparatus 100.

The voltage signal subjected to impedance matching in the matching circuit 3 is supplied to the capacitor including the upper electrode 1a and the lower electrode 1b. Hence, a high-frequency electric field is generated between the upper electrode 1a and the lower electrode 1b. After that, the product A placed between the upper electrode 1a and the lower electrode 1b is dielectrically heated.

(Controlling Clearance between Upper Electrode 1a and Lower Electrode 1b)

Described next is how to control the clearance between the upper electrode 1a and the lower electrode 1b, with reference to drawings.

The high-frequency heating apparatus 100 according to this embodiment is suitable for defrosting foods at home or in a retail store such as a convenience store. Taking into consideration the size, the quantity, and the shape of the product A assumed for use at home and in a retail store, the high-frequency heating apparatus 100 is designed so that an inter-electrode distance D between the upper electrode 1a and the lower electrode 1b is set to range from 3.0 to 27 cm. Such a feature allows a user to use the high-frequency heating apparatus 100 easily and safely.

Described here is a relationship between a height H of the product A and the inter-electrode distance D. FIG. 4 illustrates a relationship between (i) a ratio of the height H of the product A to be defrosted (to be heated) to the inter-electrode distance D and (ii) an energy rate of portions of the product A.

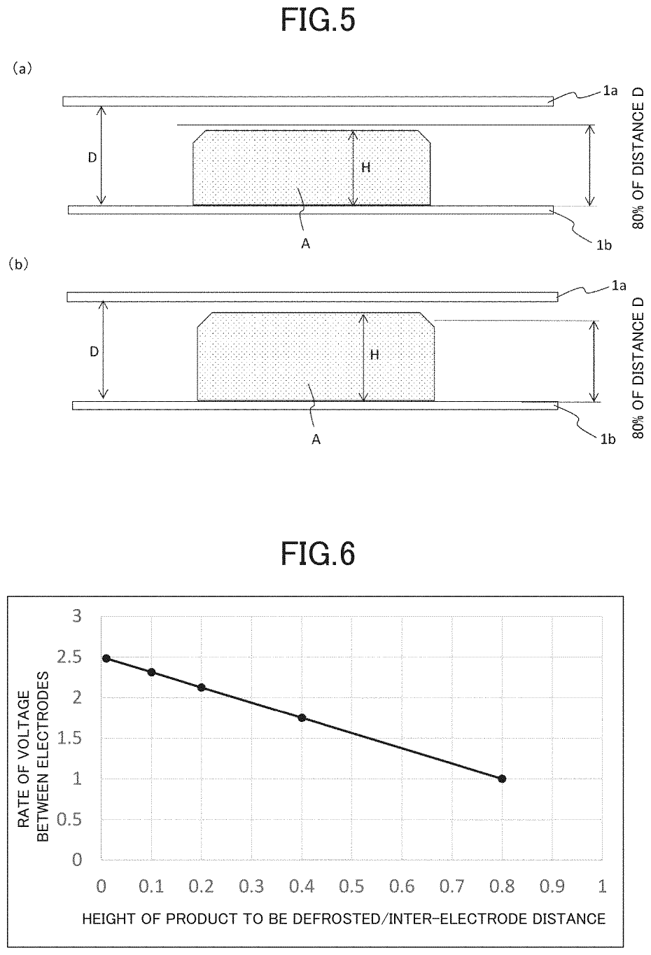

As illustrated in FIG. 5(a), if the height H of the product A is small in relation to the inter-electrode distance D (i.e., if the clearance (the space) between the product A and the upper electrode 1a is wide), a difference is small between energies to be applied to portions, of the product A, with different heights. (See the dashed-line frame illustrated in FIG. 4.) Meanwhile, as illustrated in FIG. 5(b), if the height H of the product A is great in relation to the inter-electrode distance D (i.e., if the clearance (the space) between the product A and the upper electrode 1a is narrow), a difference is large between energies to be applied to portions, of the product A, with different heights. (See the dash-dot-dash-line frame illustrated in FIG. 4.)

For example, if the ratio of the height H of the product A to be defrosted (to be heated) to the inter-electrode distance D is 0.8 or below (i.e., if the height H of the product A is 80% of the inter-electrode distance D or smaller), an energy rate of the portions of the product A can be set to 0.4 or below. (See FIG. 4.) That is, the risk of unevenly heating the product A can be reduced relatively low.

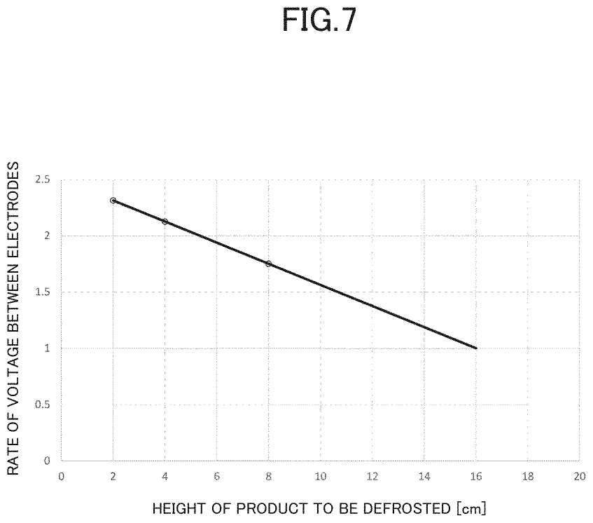

However, if the clearance (the space) between the product A and the upper electrode 1a is excessively wide, the product A has to be heated for a longer time period unless the voltage between the electrodes is raised higher. FIG. 6 illustrates a rate of a voltage to be applied between the electrodes when products A having a different height H (having a different ratio with respect to the inter-electrode distance D) are defrosted for the same time period as that for defrosting a product A whose height is 80% of the inter-electrode distance D. In FIG. 6, the value 1 (a reference value) is a voltage to be applied between the electrodes in defrosting the product A whose height is 80% of the inter-electrode distance D. Moreover, FIG. 7 illustrates a rate of a voltage to be applied between the electrodes having an inter-electrode distance D of 20 cm when products A, whose height H ranges from 2 to 16 cm, are defrosted for the same time period as that for defrosting a product A whose height H is 16 cm. Here, if the rate of the voltage between the electrodes rises above approximately 2.2, the following problems might arise; a greater risk of electrical discharge, necessity to design the matching circuit to boost the voltage, and the resulting significant increase in the size of the apparatus. Hence, the ratio of the voltage between the electrodes is preferably 2.2 or below.

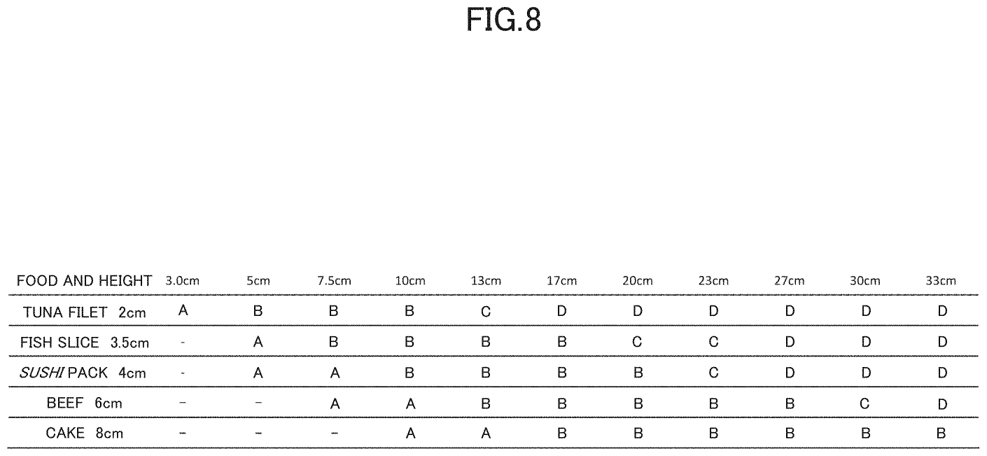

Taking the above points into consideration, a study was conducted to find an inter-electrode distance D allowing for easily defrosting, for example, a sashimi slice, a sushi piece, a meat hunk, and a cake as products A that are highly likely to be defrosted at home and in a retail store such as a convenience store. FIG. 8 shows the results of the study. Described below are criteria in FIG. 8:

A: Most suitable. High quality and defrosted most quickly.
B: Can be defrosted quickly while maintaining good quality.
C: Can be defrosted, but poor in heat efficiency and takes some time to defrost.
D: Barely defrostable, but the resulting quality is unstable. Very poor in heat efficiency and takes significant time to be defrosted.

With reference to FIG. 6, when the ratio of the voltage between the electrodes is set to 2.2 or below, the height H of a product A is preferably 15% of the inter-electrode distance D or greater. Here, assumed as the product A is nigiri-zushi. When a nigiri-zushi piece has an average height of 4 cm, the inter-electrode distance D is 27 cm or shorter to satisfy a condition that the height H is 15% of the inter-electrode distance D or greater. Such a feature makes it possible to reduce the risk that the product A (the nigiri-zushi piece) is unevenly heated in defrosting the nigiri-zushi piece with the high-frequency heating apparatus 100.

In order to further reduce the rate of the voltage between the electrodes, the height H of the product A is more preferably 20% of the inter-electrode distance D or greater. That is, the inter-electrode distance D is more preferably 20 cm or shorter.

Moreover, in order to set the inter-electrode distance D more appropriately for defrosting a fish slice whose height H is smaller (a height of 3.5 cm), the inter-electrode distance D is preferably 23 cm or shorter, and more preferably, 17 cm or shorter. (See FIG. 8.)

Moreover, in order to set the inter-electrode distance D more appropriately for defrosting a tuna filet to be used for sashimi slices whose height H is still smaller (a height of 2 cm), the inter-electrode distance D is preferably 13 cm or shorter, and more preferably, 10 cm or shorter. (See FIG. 8.)

Note that if the clearance between the product and the electrodes is narrower than 0.5 cm, the electrodes and the product are excessively close to each other such that electric discharge is likely to occur. Moreover, an actual product to be defrosted is often shaped not into a cuboid in a precise sense. Such a product as a tuna filet can be deformed by postmortem rigidity while being defrosted. This deformation could cause the product to make contact with an electrode. Hence, for a wrapping material of the product, an insulator, and a clearance, a space of 0.5 cm each for the upper and lower electrodes, that is, a space of 1.0 cm in total is preferably left between the upper and lower electrodes.

Taking into consideration the clearance to each of the electrodes, the lower limit of the inter-electrode distance D is 3.0 cm with reference to a sashimi slice (a height of 2 cm) of a tuna filet whose height H is low. The inter-electrode distance D of 3.0 cm or greater makes it possible to reliably leave a preferable clearance between electrodes and a product to be defrosted whose height H is small.

Moreover, in defrosting a product to be defrosted taller than a tuna filet, for example, the lower limit of the inter-electrode distance D can be set as follows. If the product is a sushi pack having a height of approximately 4 cm, the inter-electrode distance D is set to 5 cm or greater. If the product is a meat hunk having a height of approximately 6 cm, the inter-electrode distance D is set to 7.5 cm or greater. If the product is a cake having a height of approximately 8 cm, the inter-electrode distance D is set to 10 cm or greater.

Note that most of frozen food products such as sushi and cakes (e.g. a mont-blanc dessert and a shortcake dessert) somewhat vary in height. In order to reduce the risk of uneven temperature distribution in heating and defrosting a product whose height varies, the inter-electrode distance D is preferably set to 80% or shorter of the maximum height of the product.

As can be seen, the upper electrode 1a, connected to the movable unit 8, is vertically movable in accordance with a command from the control circuit 6. That is, the inter-electrode distance D is variable. Such a feature makes it possible to adjust the inter-electrode distance D to be most suitable in accordance with the height of the product A.

The height of the product A can be measured by, for example, a height detection sensor to be installed in the heating chamber 9. Moreover, the product A may have a bar code B including information on the height of the product A. In such a case, the reader 4 reads the bar code B to obtain the information on the height of the product A. The control circuit 6 can vertically move the upper electrode 1a on the basis of the information, obtained through the height detection sensor or the reader 4, on the height of the product A, and set the inter-electrode distance D to be most suitable within a range from approximately 3.0 cm or greater to approximately 27 cm or shorter in accordance with the kind and the height H of the above described product A. Here, the inter-electrode distance D of approximately 3.0 cm means that a median of the inter-electrode distance D is 3.0 cm with a margin of approximately plus or minus 1.0 cm. Moreover, the inter-electrode distance D of approximately 27 cm means that a median of the inter-electrode distance D is 27 cm with a margin of approximately plus or minus 1.0 cm.

Such a feature makes it possible to further reduce the risk of uneven temperature distribution in heating various kinds of products to be heated. Furthermore, the inter-electrode distance D is set within a range from approximately 3.0 cm or greater to approximately 27 cm or shorter, also making it possible to downsize the high-frequency heating apparatus 100.

(Area of Upper Electrode 1a and Lower Electrode 1b)

Described next is a surface area (an opposing face to the product A) of the upper electrode 1a and the lower electrode 1b. Described here is an example in which the upper electrode 1a and the lower electrode 1b are formed of plate electrodes that are the same in shape and area. Note that, in another aspect of the present invention, at least one of the upper electrode 1a and the lower electrode 1b may be divided into two or more. In such a case, an area of the electrode is the total sum of the surface areas of the divided plate electrode (the opposing faces to the product).

Typically, an electrode with a small area is difficult to defrost a product larger in size than the electrode. Meanwhile, an electrode with a large area increases an amount of current, thereby increasing wiring power loss. Hence, the cooling mechanism such as a fan in the heating chamber has to have higher capacity. However, a larger heat exhausting fan for cooling inevitably increases the size of the apparatus, making it difficult to design a high-frequency heating apparatus to fit a size for use at home and in restaurant kitchens.

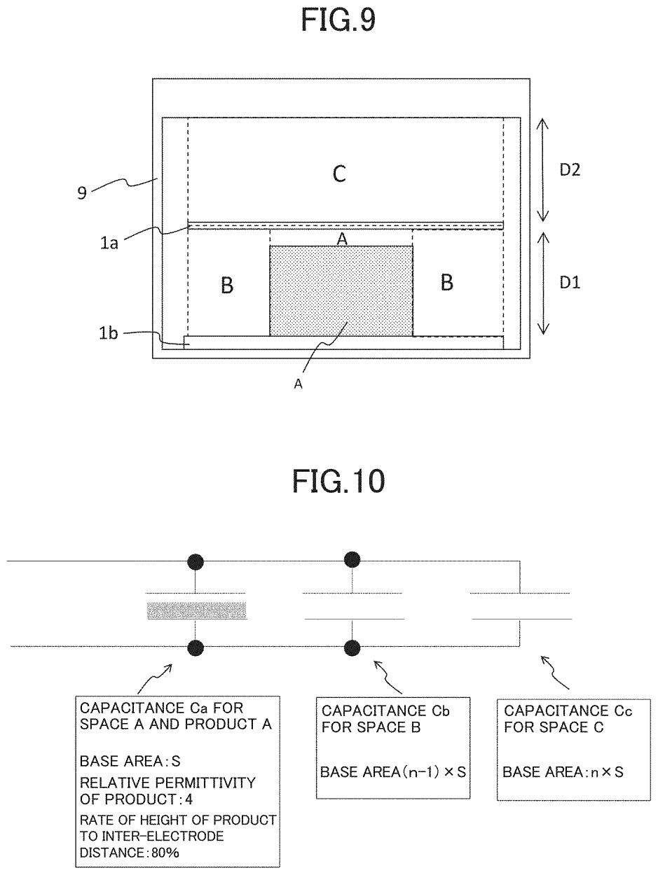

Described below is a relationship between (i) dimensions of the interior of the heating chamber 9 and dimensions of the electrodes and (ii) dimensions of the product A, with reference to, for example, FIGS. 9 and 10. FIG. 9 schematically illustrates spaces defined when the product A is placed on the lower electrode 1b in the heating chamber 9.

As illustrated in FIG. 9, when the product A is placed on the lower electrode 1b, a space B without the product A is defined between the upper electrode 1a and the lower electrode 1b. The upper electrode 1a and the lower electrode 1b, which receives a high voltage, are arranged in a casing (i.e., inside a ground) made of metal. Hence, defined above the upper electrode 1a is a region for a space C.

When a high-frequency voltage is applied to the electrodes, the space A, the product A, the space B, and the space C constitute a capacitor. The space B and the space C conduct a high-frequency current that does not provide energy to the product A. A decrease in a height D2 of the space C increases the high-frequency current flowing through the space C. Moreover, the decrease in the height D2 increases an intensity of the electric field between the upper electrode 1a and the casing, possibly causing electric discharge. Meanwhile, an increase in the height D2 of the space C decrease the high-frequency current; however, the increase in the height D2 enlarges an idle space, and thus the size of the apparatus per se.

FIG. 10 illustrates the spaces in the form of capacitors as an equivalent circuit when the space B and the space C are the same in height (i.e., D1=D2=D), and an electrode area is n times a base area of the product A.

Here, the capacitances Ca, Cb, and Cc of the respective spaces can be obtained as follows:

Ca=2.5ε₀·S/D

Cb=ε₀·(n−1)·S/D

Cc=ε₀·n·S/D

When a voltage of “1” is applied to each of the capacitors, an “all current/product-to-be-defrosted current” is represented as follows. The term “all current” is a total value of currents running in the circuit, and the term “product-to-be-defrosted current” is a value of a current running in the space A and the product A.

{(2n−1)/2.5+1}

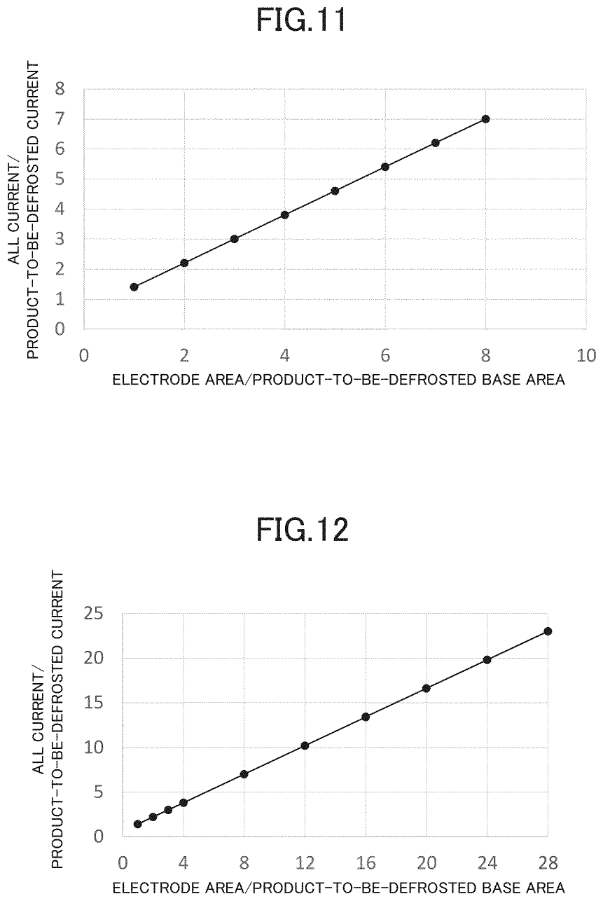

As the value n varies in the above expression, the “all current/product-to-be-defrosted current” with respect to an “electrode area/product base area (n)” is illustrated in a graph in FIGS. 11 and 12. FIG. 11 illustrates a graph where n=1 to 8, and FIG. 12 illustrates a graph where n=1 to 28.

A study has been conducted to design the apparatus, reflecting demands for defrosting various food products to be prepared at home or in restaurant kitchens, and an amount of exhausted heat and a required size of a heat exhausting fan. The resulting rate of the wiring power loss is preferably reduced to 15 or smaller.

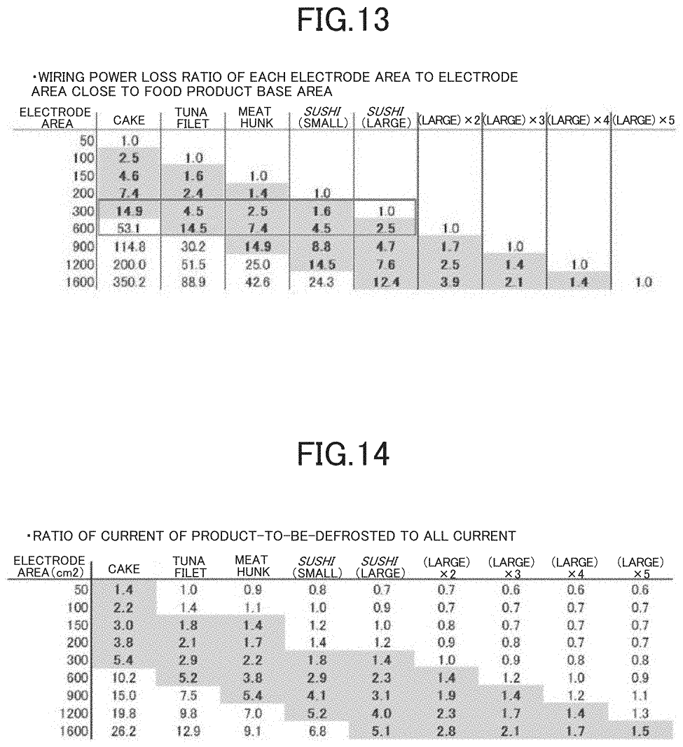

Here, calculated is the wiring power loss in defrosting such food products as, for example, a frozen cake, a sashimi slice (e.g., a tuna filet), a meat hunk, a sushi pack (small), and a sushi pack (large). These food products are expected to be relatively high in demand for defrosting. In the calculation, the base areas of the respective food products are assumed to be approximately, 50 cm², 100 cm², 150 cm², 200 cm², and 300 cm². FIG. 13 shows the results of the calculations.

When the electrode is designed to have an area range from 300 cm² to 1,200 cm², the defroster can be produced small to easily and quickly defrost such frozen food products as sushi at retail stores. Moreover, with reference to the results in FIG. 13, an electrode area of 600 cm² or smaller shows that, without precise settings for each of the food products, the wiring power loss ratio can be maintained at a fair level among relatively wide variety of food products (i.e., ingredients such as a tuna filet and a meat hunk, and prepared food products such as sushi packs). Note that, the cake shows a relatively high wiring power loss when the electrode area is 600 cm². In defrosting such a food product with a relatively small area, two more of the food products (e.g., two food products) are simultaneously defrosted, making it possible to curb the wiring power loss ratio low.

Moreover, FIG. 14 shows the results of the calculations of the “all current/product-to-be-defrosted current (a ratio of a current of product-to-be-heated to all currents)” in defrosting the same food products (i.e., a frozen cake, a sashimi slice (e.g., a tuna filet), a meat hunk, a sushi pack (small), and a sushi pack (large)) as those in FIG. 13. As seen in FIG. 13, the base areas of the frozen cake, the sashimi slice (e.g., a tuna filet), the meat hunk, the sushi pack (small), and the sushi pack (large) are assumed to be approximately 50 cm², 100 cm², 150 cm², 200 cm², and 300 cm².

When the high-frequency heating apparatus 100 defrosts the food products, the “all current/product-to-be-defrosted current” is preferably set to 5.5 or below. Such a feature makes it possible to curb an increase in the wiring power loss. Moreover, with reference to FIG. 14, the electrode area of the high-frequency heating apparatus 100 preferably ranges from 300 cm² to 600 cm² in order to curb an increase in the wiring power loss and allow for defrosting a larger variety of food products.

Summary of First Embodiment

Described above is an embodiment of the present invention. Stated below are conventional techniques from which the present invention is derived, and problems of the conventional techniques.

Microwave ovens are widely in use as conventional defrosters to defrost frozen food at home and relatively small facilities such as restaurant kitchens and convenience stores. A microwave oven, a microwave cooker, uses an electromagnetic wave of 2.45 GHz to energize and vibrate water molecules to raise the temperature.

Other than the microwave oven, there is another technique for defrosting by internal heating, that is, heating with microwaves transmitted from an amplifier including a semiconductor element. Other than the above techniques for defrosting, there is still another technique for raising the temperature of a product to be heated by heat transfer from outside, such as by ambient air. Specifically, the technique involves leaving frozen food inside a refrigerator, under room temperature, or in running water.

Moreover, larger facilities, such as factories producing prepared side dishes and box lunches and central kitchens of restaurant chains, use industrial defrosters cooking with HF waves or VHF waves. These industrial defrosters defrost a large amount of food products such as blocks of frozen whitebait and hunk meat by several kilograms.

HF waves or VHF waves are more advantageous than microwaves because of the three reasons below:

a) A difference in loss coefficient between water and ice is small, reducing the risk of thermal runaway; that is, meltwater from ice is heated more intensely.

b) A power half depth is greater as a frequency is lower, allowing the energy to penetrate deeper into a product to be defrosted.

c) As the product is defrosted and ice thaws into water, a high-frequency voltage is less likely to be applied (that is, the product is less likely to be heated). Hence, the product is readily defrosted partially to a temperature ranging from −5° C. to −1° C. without causing the thermal runaway.

Recent years have seen a remarkable improvement and change in techniques, infrastructures, and circumstances related to food distribution systems.

In the technical aspect, for example, significant developments have been encouraged of such freshness-maintenance techniques as: the ikejime technique for closing fish on a fishing boat in the sea or at a sea port; and sophisticated freezing techniques, including the cells alive system (CAS) and the proton freezing, to preserve freshness. Moreover, in the infrastructural aspect such as distributions, freezing facilities and refrigerated transport services such as chilled-package delivery services, are being developed, offering an environment for preserving frozen and refrigerated food products for delivery. The developments of infrastructures are rapidly accelerating growth of services that involve delivery of high-end products directly to individual customers while preserving their freshness; that is, services of direct deliveries from, and orders to, producers.

Such changes of circumstances related to food have significantly altered peoples' interests in food and their dietary habits all over the world as follows:

a) Economic progress, as well as the improvement in the freshness-maintenance techniques and the development of the infrastructural aspect as described above, has increased prices and consumption of meat and fish all over the world. Sushi and sashimi, sea food served raw and thus used to be rather unacceptable, are now unquestionably people's favorites as sophisticated high-end dishes.

b) In addition to an improvement in the techniques and a development of the infrastructures, distribution systems have been rationalized and streamlined, leading to establishment of higher criteria for freshness of food products. Catchy sales pitches such as “delivered directly from producers” and “harvested in the morning” are the norm of the day. Fish caught in the morning is now offered to diners as lunch at such restaurants as circulating such eateries.

c) While featuring freshness, the food industry faces a problem of food waste in terms of management and ethics. Hence, the industry has devised various techniques to extend best-before dates. Examples of the techniques include: preservation and processing techniques such as smoking; food preservation techniques using such food additives as preservatives and antioxidants; and packaging techniques represented by canning and vacuum packaging.

d) Frozen food has improved in quality, convenience, and taste. The frozen food can offer freshly cooked meals easily prepared with such heating cookers as microwave ovens. Thanks to such convenience, the frozen food has grown to form a large market.

e) Due to a change in people's sense of values to, and concerns about safety of, their dietary habits, people have started to support natural food products such as additive-free and organic ones. As alternatives to food additives, required of the take-out food industry and the restaurant industry are measures enabling long-term preservation by sophisticated freezing and packaging techniques, and simultaneously achieving preservation of freshness and texture of food.

As can be seen, the circumstances around the food distribution systems are drastically changing. Accordingly seen are various improvements in techniques for processing frozen food. In contrast, current defrosting techniques develop such problems as excessive heating and deterioration in texture. In particular, improvements are still insufficient as to techniques for defrosting frozen food quickly to room temperature or a suitable temperature at home and relatively small facilities such as restaurant kitchens. For example, it is difficult for conventional techniques such as microwave ovens to easily defrost such foods as sushi, a fresh sweet, and a cake with whipped cream on top to be served at a normal temperature from several degrees Celsius to approximately twenty degrees Celsius, while the quality of the foods is maintained high. Here are examples of problems.

Compared with water, microwaves of a microwave oven are less likely to be absorbed by ice because of the difference in loss coefficient. Such a character of the microwaves poses disadvantages in defrosting as follows:

1) Taking excessive time. This is because, in the so-called “defrost mode”, the microwave oven heats frozen food with lower power to prevent damage caused by microwaves reflected on the cavity magnetron.

2) Likely to cause uneven defrosting. In the case of defrosting a meat hunk, for example, the meat hunk is heated intensely to a depth of approximately 2 cm from the surface. Whereas, the electromagnetic waves do not reach the center of the hunk, causing a difference in temperature between the surface and the center of the defrosted meat hunk.

3) Likely to cause local heating. When the surface of the frozen product is intensely heated as described above, and as soon as the surface becomes watery, the watery surface suddenly starts to absorb the microwaves, causing a phenomenon called “thermal runaway.”

When the product is left at room temperature to be defrosted, the temperature is distributed uniformly through the product in accordance with the ambient air. Such a technique, however, has disadvantages below:

1) Defrosting can take several hours or more, depending on amounts and shapes of food products. At restaurant kitchens, frozen food is often defrosted from the eve of the day when the food is used.

2) Defrosting for a long time period causes degradation of food including deteriorating taste by oxidation and draining juice through drips. (This is because the food spends a long time in the maximum ice crystal generation temperature zone, and membranes of the food suffer damage.)

3) Defrosting for a long time period poses a risk of proliferation of mildew and bacteria on the surface of the defrosted food, causing food poisoning. In particular, when the food is served raw, the risk increases from a health view point.

Defrosting in running water can defrost food in a relatively short period of time; however, the method poses two disadvantages below:

1) The amount of time for defrosting varies, depending on such a condition as room temperature. Hence, extra labor is required for time management for, and frequent checks of, the defrosting food.

2) For defrosting by running water, suitable conditions have to be met (i.e., a space to be occupied with a large capacious of sink, packaging such as vacuum packing, and installation of plumbing). In addition, defrosting a chunky food product such as a meat hunk requires some time.

As can be seen, defrosters using HF waves or VHF waves are more advantageous in defrosting than microwaves using microwaves. Such defrosters are widely used as industrial defrosters at large facilities. The HF waves or the VHF waves are great in power half depth, and arc suitable to defrosting food in a large size by several kilograms; whereas, the HF waves or the VHF waves are not suitable to defrosting ready-to-eat food to be sold at retail stores to personal consumers. Moreover, the current defrosters using HF waves or VHF waves are intended to defrost a food product made of a single ingredient. If the food product is made of various kinds of ingredients, an ingredient having a higher dielectric loss is heated more intensely. Hence, when such a defroster defrosts, for example, different food products arranged in small portions for a box lunch, the food products are unevenly heated.

Hence, the typical defrosters using HF waves or VHF waves are neither suitable to defrosting at small facilities such as store kitchens in which a necessary amount of food is defrosted in a small portion, nor downsized for such a use. Hence, such defrosters using HF waves or VHF waves are not widely available for households and store kitchens of convenience stores, unlike microwave ovens are.

Furthermore, as to high-frequency heating apparatuses utilizing dielectric heating with high-frequency electric fields of HF waves or VHF waves, such settings as the most suitable output power, a reactance component of a matching circuit, and a drive time period vary depending on products to be defrosted (to be heated). Hence, the high-frequency heating apparatuses are required to comprehensively control these settings. However, a food heating and cooking apparatus (a microwave oven) disclosed in Patent Document 1 controls the drive time alone. If this technique is applied to the high-frequency heating apparatus according to this embodiment, the high-frequency heating apparatus cannot defrost a product with its quality maintained high, and might cause excessive heating, insufficient heating, and uneven heating.

Moreover, Patent Document (Japanese Unexamined Patent Application Publication No. 2004-349116) proposes a method for uniformly heating products to be heated in different shapes and heights, using a dielectric heating apparatus using HF waves or VHF waves. In this method, the products are covered with a subject having the same relative permittivity as or greater than that of the products, so that the subject confines the products in a narrow space. Hence, the method prevents the heat from locally concentrating. However, if the apparatus is frequently and repeatedly used at such a place as a restaurant kitchen and a convenience store, a user faces a difficulty in such work as loading and unloading a product into and from the apparatus. During the work, the product would be in contact with the subject, damaging the product itself and the subject. Such a disadvantage causes problems in view of the usability, life, and maintenance of the apparatus.

As can be seen, an increasing number of consumers in recent years would like to readily eat at any time end products such as sushi and fresh sweets with least food additives possible. Hence, freezing techniques for preserving those foods are drastically improving. In contrast, defrosting techniques fall behind the improvement in the freezing and refrigerating techniques. At this moment, no satisfactory defrosting technique is commonly available. In particular, there is still no versatile defroster capable of defrosting food for required servings to an appropriate temperature at a relatively short time period, with the quality of the food maintained, in home kitchens and kitchens at retail stores where the food is prepared to be immediately served.

Hence, in view of the above problems, an aspect of the present invention provides a defroster (a high-frequency heating apparatus) which is easy to operate as a microwave oven is.

The high-frequency heating apparatus 100 according to an aspect of the present invention includes: the upper electrode 1a; the lower electrode 1b; the voltage applicator 20 (the high-frequency power supply 2 and the matching circuit 3) applying a high-frequency voltage between the upper electrode 1a and the lower electrode 1b; and the movable unit 8 connected to the upper electrode 1a. The movable unit 8 can change the clearance between the upper electrode 1a and the lower electrode 1b.

In the high-frequency heating apparatus 100 according to this embodiment, the inter-electrode distance D between the two electrodes (the upper electrode 1a and the lower electrode 1b) ranges from 3.0 to 27 cm. Moreover, the upper electrode 1a and the lower electrode 1b, shaped into a plat plate, each have an area of 600 cm² or smaller. Thanks to such a feature, the high-frequency heating apparatus 100 is sized suitably for use in small facilities such as houses and retail stores, allowing the apparatus to be highly versatile.

The high-frequency heating apparatus 100 according to this embodiment can be used in small spaces, in which large machinery cannot be installed, including retail stores such as convenience stores, restaurant kitchens, and home kitchens. Moreover, the high-frequency heating apparatus 100 can be designed to have the same size and weight as those of a microwave oven, so that the apparatus can be transported, moved, and installed by just one user alone. Furthermore, the high-frequency heating apparatus 100 eliminates the need for precise settings for physical conditions of products to be heated, as the apparatus disclosed in a patent document (Japanese Unexamined Patent Application Publication No. 2004-349116) is required. Without compromising durability and convenience, such a feature makes the high-frequency heating apparatus 100 handy and easy to use.

Moreover, in the high-frequency heating apparatus 100, the ratio of all current to a product-to-be-defrosted current is set to 5.5 or below when the product is heated. Such a feature makes it possible to reduce wiring power loss.

Furthermore, the movable unit 8 can move the upper electrode 1a, so that the inter-electrode distance D can be set most appropriately within the above range in accordance with the height of the product. Such a feature reduces the risks of excessive heating, insufficient heating, and uneven heating, making it possible to defrost the product with its quality maintained high.

The high-frequency heating apparatus 100 further includes: the reader 4 reading, for example, the kind and the size of the product A; the memory 5 storing the product A in association with the control information on heating the product A; and the control circuit 6 changing the heating time period and the output power on the basis of the control information associated with the product A and identified by the reader 4.

Such a feature makes it possible to set an appropriate heating condition for each kind and ingredient of food products in a larger variety. The feature, for example, makes it possible to accurately identify each of the products sold in several dozen kinds simply for box lunches alone at such a store as a convenience store, and to select a heating program suitable to the identified product. Moreover, if the product is a standard product whose weight, shape, and size are predetermined, the feature makes it possible to set a defrosting condition most suitable to the product through reading a bar code, without manual date entry.

Furthermore, by identifying the kind of the product, the feature makes it possible to heat (defrost) the product to the most appropriately finished temperature suitable to the characteristics of the product. If the product is raw meat to be cooked to serve, the product can be either partially defrosted or defrosted to a finished temperature of approximately 0° C. If the product is frozen sushi, the product can be defrosted to a finished temperature of approximately 20° C. Moreover, if the product is a cake including whipped cream, the product can be defrosted to a finished temperature of approximately 5° C. In addition, the heating chamber 9 includes the radiant heat sensor 21, making it possible to install a heating program suitable to a condition of the product before heated. If the temperature of the product before heated is high, for example, the product may be heated for a short time period.

Furthermore, if the high-frequency heating apparatus 100 includes a weight sensor, the high-frequency heating apparatus 100 can change a heating time period (a defrosting time period) and output power (an output wattage rating), reflecting weight information to be transmitted from the weight sensor.

As can be seen, the high-frequency heating apparatus 100 can identify a kind of a product to be heated with the reader 4 and the operation unit 7, and determine a state of the product with various kinds of sensors such as the radiant heat sensor 21 and the weight sensor. Hence, the control circuit 6 can precisely control defrosting in accordance with the kind and state of the product. Such a feature makes it possible to finish the product in the most suitable state. Moreover, such various sensors as the radiant heat sensor 21 and the weight sensor can partially or fully automate the control.

In addition, the high-frequency heating apparatus 100 according to an aspect of the present invention can defrost frozen food products on demand in a short time period at a small restaurant where demand of the food products is uncertain. Such a feature makes it possible to reduce the risks of food waste and opportunity loss. Moreover, the food products can be defrosted in a short time period with their quality maintained. Compared with the case where the food products are left to be naturally defrosted, such a feature makes it possible to curb an increase in bacteria causing food poisoning during defrosting. Hence, the high-frequency heating apparatus 100 can contribute to food safety.

### Second Embodiment

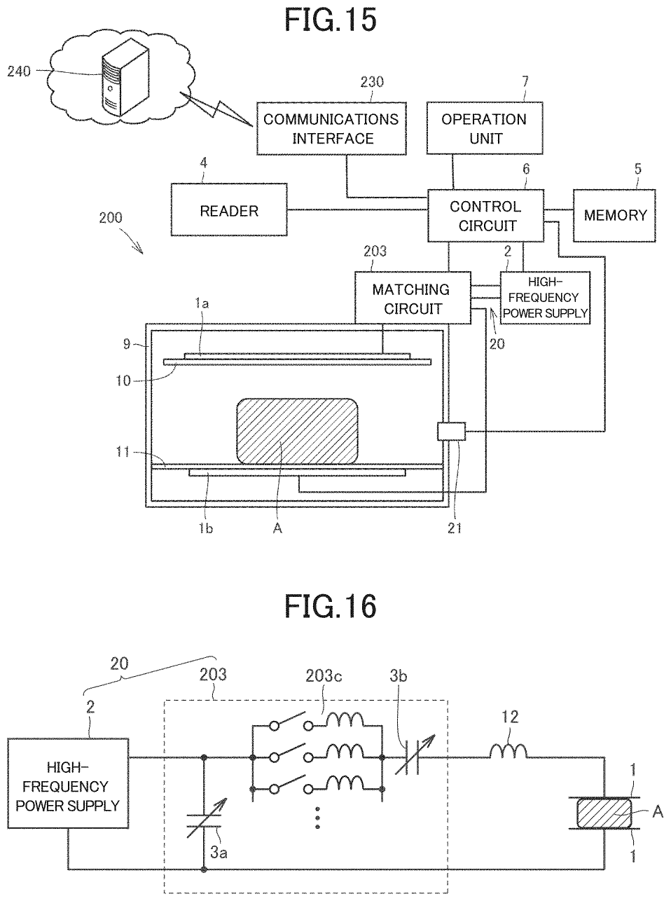

Described next is a second embodiment of the present invention. FIG. 15 illustrates an internal configuration of a high-frequency heating apparatus 200 according to the second embodiment.

The high-frequency heating apparatus 200 includes a heating chamber (a defrosting chamber) 9. Moreover, outside the heating chamber 9, the high-frequency heating apparatus 200 illustrated in FIG. 15 includes: the voltage applicator 20; the control circuit (the controller) 6; the reader 4; the operation unit (the input unit) 7; and the memory 5. The comparison between FIG. 15 and FIG. 1 shows that the high-frequency heating apparatus 200 is different from the high-frequency heating apparatus 100 according to the first embodiment in that the former does not include the movable unit 8. Moreover, a matching circuit 203 is different in internal configuration from the matching circuit 3 according to the first embodiment. The other constituent features of the high-frequency heating apparatus 100 can be applicable to the high-frequency heating apparatus 200. Such constituent features will not be repeatedly elaborated upon.

FIG. 16 illustrates a circuitry configuration between the electrodes 1a and 1b and the high-frequency power source 2. The voltage applicator 20 applies a voltage to the electrodes inside the heating chamber 9.

The voltage applicator 20 applies a high-frequency voltage between the upper electrode 1a and the lower electrode 1b. The voltage applicator 20 includes such main features as: the high-frequency power supply 2; and the matching circuit 203. The high-frequency power supply 2 may be the same in configuration as that in the first embodiment.

The matching circuit 203 includes for example: the variable capacitors (variable reactance elements) 3a and 3b; and a variable coil (a variable reactance element) 203c. The variable capacitors 3a and 3b may be the same in configuration as those in the first embodiment.

The variable coil 203c includes a plurality of coils to be connected selectively. Such a feature allows the variable coil 203c to be switched to two or more inductances.

Thanks to such a feature, the matching circuit 203 offsets a reactance of the capacitor including the upper electrode 1a and the lower electrode 1b. Moreover, the matching circuit 203 adjusts values of the variable capacitors 3a and 3b, and the variable coil 203c, making it possible to match an input impedance in the matching circuit 203 to an output impedance in the amplifier. Such a feature makes it possible to efficiently apply a high-frequency electric field to the product A to be heated (to be defrosted).

Similar to the first embodiment, the coil 12 is disposed between the variable capacitor 3b of the matching circuit 203 and the upper electrode 1a.

Controlling Capacitance of Variable Capacitors 3a and 3b

The memory 5 of the high-frequency heating apparatus 200 according to this embodiment stores, as information for controlling heating of the product A, a capacitance of the variable reactance elements (the variable capacitors 3a and 3b) inside the matching circuit 203. On the basis of the information stored in the memory 5 for controlling the capacitance of the variable reactance elements (the variable capacitors 3a and 3b), the control circuit 6 controls the capacitance of the variable capacitors 3a and 3b inside the matching circuit 203.

The high-frequency heating apparatus 200 adjusts the variable reactance elements (the variable capacitors 3a and 3b, and the variable coil 203c) of the matching circuit 203, making it possible to efficiently apply a high-frequency electric field to a food product, and to efficiently defrost the product so that the temperature of the product is less likely to be distributed unevenly while its quality is maintained high.

Inter-Electrode Distance Between Upper Electrode 1a and Lower Electrode 1b

Described next is an inter-electrode distance between the upper electrode 1a and the lower electrode 1b. The high-frequency heating apparatus 200 according to this embodiment is suitable for defrosting food at home and a retail store such as a convenience store. Reflecting the size, the quantity, and the shape of the product A assumed for use at home and in the retail store, the high-frequency heating apparatus 200 is designed so that the inter-electrode distance D between the upper electrode 1a and the lower electrode 1b is set to range from 3.0 to 27 cm. Such a feature allows the high-frequency heating apparatus 200 to be downsized.

Note that the high-frequency heating apparatus 200 according to this embodiment does not include the movable unit 8. Hence, the inter-electrode distance D between the upper electrode 1a and the lower electrode 1b is set to range from 3.0 to 27 cm. Taking the use of the high-frequency heating apparatus 200 into consideration, the inter-electrode distance D is preferably set with reference to a height H of a food product to be used more frequently.

For example, the inter-electrode distance D is preferably set so that a ratio of the height H of the product A to be defrosted (to be heated) to the inter-electrode distance D is 0.8 or below (i.e., if the height H of the product A is 80% of the inter-electrode distance D or smaller). Such a feature makes it possible to set an energy rate of the portions of the product A to 0.4 or below (see FIG. 4). That is, the feature can curb uneven heating of the product A to a relatively lower degree.

Note that the high-frequency heating apparatus 200 according to this embodiment can be used as a dialectic heating apparatus of a defrosting system which defrosts a frozen sushi set by dielectric heating with a high-frequency electric field of HF waves or VHF waves. In this case, the high-frequency heating apparatus 20 includes a communications interface 230 acting as a receiver receiving an instruction for defrosting the frozen sushi set (see FIG. 15).

This defrosting system mainly includes: the high-frequency heating apparatus 200; and a server 240. The high-frequency heating apparatus 200 can be connected to the server 240 through, for example, the Internet and a router.

The communications interface 230 in the high-frequency heating apparatus 200 is an antenna and a connector. The communications interface 230 receives various kinds of signals, data, and instructions to be transmitted from the server 240. In this defrosting system, for example, a user having an information terminal accessible to the server 240 carries out a predetermined operation to place an order for a sushi pack. The information on the order is transmitted to the server 240. The server 240 then selects an appropriate frozen sushi pack from among various kinds of frozen sushi packs stored in such a place as a freezer of a sushi producer. The selected frozen sushi pack is defrosted with the high-frequency heating apparatus 200 and provided to the user.

The above example cites a case where the receiver is included in the high-frequency heating apparatus 200. In another aspect of the present invention, the receiver can be separated from the high-frequency heating apparatus 200. Instead of the high-frequency heating apparatus 200, the high-frequency heating apparatus 100 can be used to constitute a similar defrosting system.

The above defrosting system can provide the following service: When a customer places an order for a sushi pack at a store or on the Internet a person of the store (e.g., a store clerk) defrosts a frozen sushi set with a dielectric heating apparatus (e.g., the high-frequency heating apparatus 200). The store clerk then provides the defrosted sushi set to the customer. Such a service-and-sales system for sushi sets is also an example of this invention.

Since it is difficult to defrost frozen sushi well with a microwave oven, sushi has to be refrigerated when sold at a retail store. Refrigerated sushi expires relatively soon, and the retail store has no other choice but to throw away unsold sushi.

When the retail store is provided with the dielectric heating apparatus suitable for defrosting food, the food can be preserved frozen, and the retail store can defrost the food when needed and as needed with the quality of the food maintained high. Such a feature reduces the risk that expired sushi is thrown away as food waste, and even, for example, convenience stores can readily sell sushi.

### Third Embodiment

Described next is a third embodiment of the present invention. The third embodiment describes frozen food suitable to be defrosted with the high-frequency heating apparatus 100 or the high-frequency heating apparatus 200 described above. The frozen food (specifically a frozen sushi piece 300) described in this embodiment is a frozen food product according to an aspect of the present invention.

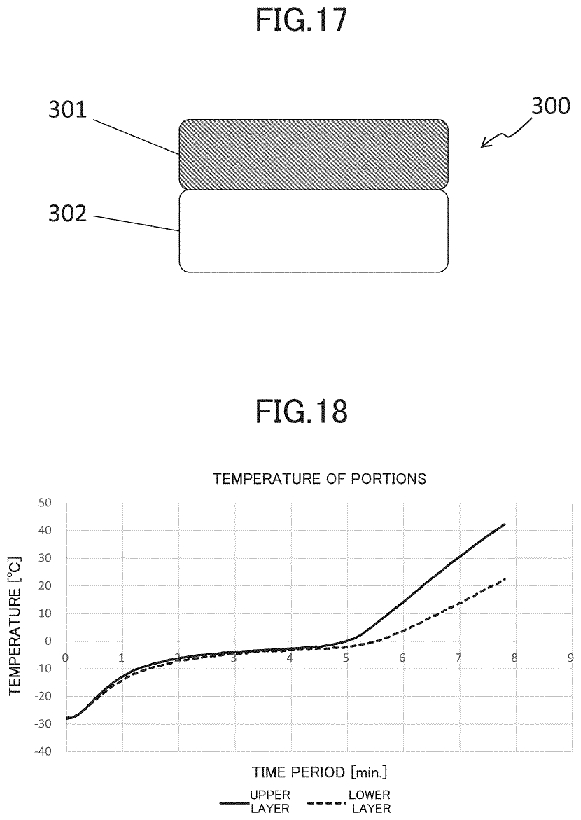

FIG. 17 illustrates an appearance of the frozen sushi piece 300 according to this embodiment. When served, the frozen sushi piece 300 is defrosted by dielectric heating with a high-frequency electric field of HF waves or VHF waves. The dielectric heating with a high-frequency electric field of HF waves or VHF waves can be carried out, using the high-frequency heating apparatus 100 or the high-frequency heating apparatus 200 described above.

The frozen sushi piece 300 includes: a neta topping (an upper layer) 301 positioned above; and a shari rice base (a lower layer) 302 positioned below. When defrosted using, for example, the high-frequency heating apparatus 100, the neta topping 310 is positioned above and the shari rice base 302 is positioned below. The shari rice base 302 is placed on the bottom face plate 11 and defrosted.

In the frozen sushi piece 300, the neta topping 301 on the top is higher in water content than the shari rice base 302 on the bottom. The water content here is an amount (a weight) of water per unit volume.

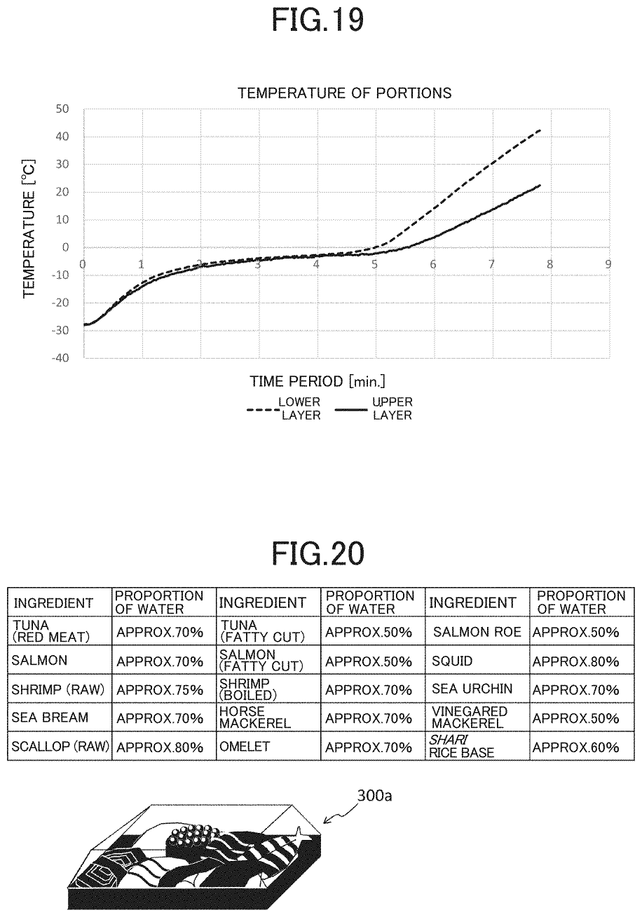

In defrosting with a dielectric heating apparatus using an electric field of VHF waves or HF waves, a frozen food product with a higher water content is heated more quickly than that with a lower water content. Such a characteristic is described with reference to FIGS. 18 and 19.

FIG. 18 is a graph illustrating a temperature rise by defrosting a frozen food product to be heated with an electric field of VHF waves or HF waves when an upper layer is higher in water content than a lower layer. As illustrated in FIG. 18, the temperature of the upper layer with a higher water content rises more gradually than that of the lower layer.

FIG. 19 is a graph illustrating a temperature rise by defrosting a product to be heated with an electric field of VHF waves or HF waves when an upper layer is lower in water content than a lower layer. As illustrated in FIG. 19, the temperature of the upper layer with a lower water content rises more quickly than that of the lower layer.

As can be seen, in defrosting by dielectric heating using an electric field of VHF waves or HF waves, a product with a lower water content is heated more quickly. Thus, the upper layer and the lower layer, each having a different water content, can be intentionally heated to a different temperature.

Usually, sushi is deemed tasty when the shari rice base is warmer than the neta topping. When the difference in temperature is intentionally created between the upper layer and the lower layer, the sushi can taste better when served.

FIG. 20 shows water contents (water percentages %) of main ingredients for sushi. As shown in FIG. 20, the shari rise base has a water content of approximately 60%. In order to create an ideal difference in temperature between the upper layer and the lower layer, a neta topping to be selected is higher in water content than the shari rice base. The resulting sushi pack can taste better when served.

In an example shown in FIG. 20, a water content of tuna (fatty cut), salmon (fatty cut), salmon roe, and vinegared mackerel is lower than 60%; that is, lower than the water content of a shari rice base. If such neta toppings are used with the same shari rice bases for other neta toppings, the ideal difference in temperature between the upper and lower layers cannot be created. When such neta toppings with a low water content are used to produce a frozen sushi pack 300a including assorted sushi pieces, a water content of shari rice bases to be used is adjusted lower than that of the neta toppings. Hence, the neta toppings with a low water content can create the temperature difference. Alternately, in selecting neta toppings for the frozen sushi pack 300a, a neta topping having a water content of 60% or lower can be excluded.

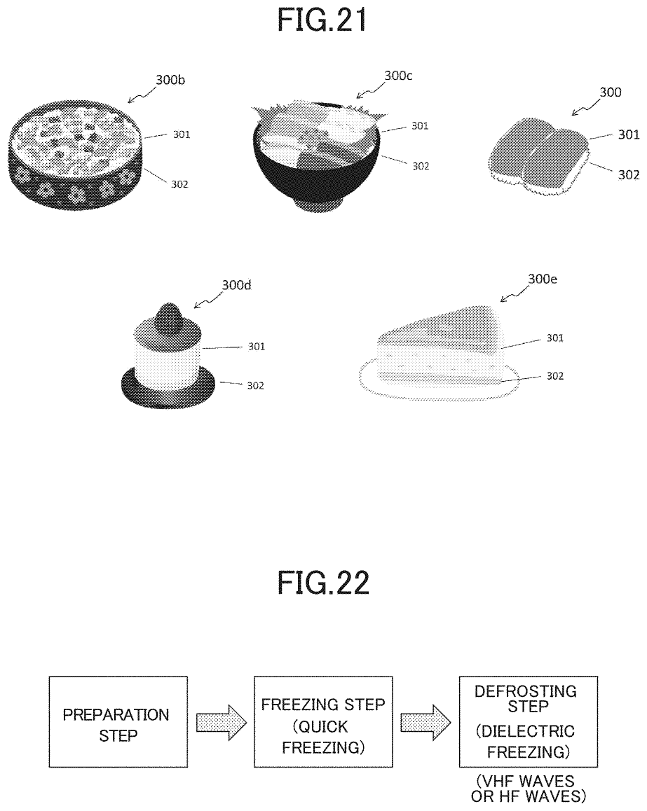

Note that, in this embodiment, the frozen sushi piece 300 is cited as an example of a frozen food product. Alternatively, the frozen food product may be any given one including an upper layer and a lower layer. FIG. 21 illustrates other examples of the frozen food product including: a frozen chirashi “scattered” sushi dish 300b; a frozen fish-on-rice bowl 300c; a frozen mousse cake 300d; and a frozen cheese cake 300e. Each of these food products includes the upper layer 301 (such as a neta topping, mousse, and cheese), and the lower layer 302 (such as vinegared rice, plain rice, and sponge) lower in water content than the upper layer 301.

As can be seen, the frozen food product according to this embodiment includes: the upper layer 301; and the lower layer 302 lower in water content than the upper layer 301. When the frozen food product is dielectrically heated with, for example, the high-frequency heating apparatus 100, such a feature makes it possible to raise the temperature of the lower layer 302 relatively quickly and keep the upper layer 301 from being excessively heated, and to intentionally create a difference in temperature between the upper layer 301 and the lower layer 302.

Moreover, in a double-layer frozen food product including an upper layer and a lower layer, a water content per unit volume of the lower layer is preferably 65% or higher and 95% or lower than a water content per unit volume of the upper layer. The water contents here are calculated in percentage to weight.

When the water contents of the upper layer and the lower layer are adjusted as described above, the difference in temperature between the upper layer and the lower layer can be optimized.

### Fourth Embodiment

Described next is a fourth embodiment of the present invention. The fourth embodiment describes a method for producing a food product according to an aspect of the present invention. FIG. 22 illustrates steps of the method for producing a food product according to this embodiment.

As illustrated in FIG. 22, the method for producing a food product according to this embodiment mainly includes three steps: namely, a preparation step, a freezing step, and a defrosting step. Each step will be described below.

The preparation step involves preparing a food product. In this preparing step, foods to be used for such a food product as a box lunch and a sushi pack are prepared in a similar manner carried out in a typical preparation step. This is how the food product is prepared. The typical preparation step will not be elaborated upon here.

The freezing step involves freezing the prepared food product. In the freezing step, the food product is quickly frozen to a temperature of −20° C. within 120 minutes from the start of freezing. Examples of the quick freezing technique include such a typically known techniques as: air blasting (freezing with cold air); immersion in a liquid (freezing with a liquid); contact freezing (freezing in contact with a freezing plate); and using a liquefied gas.

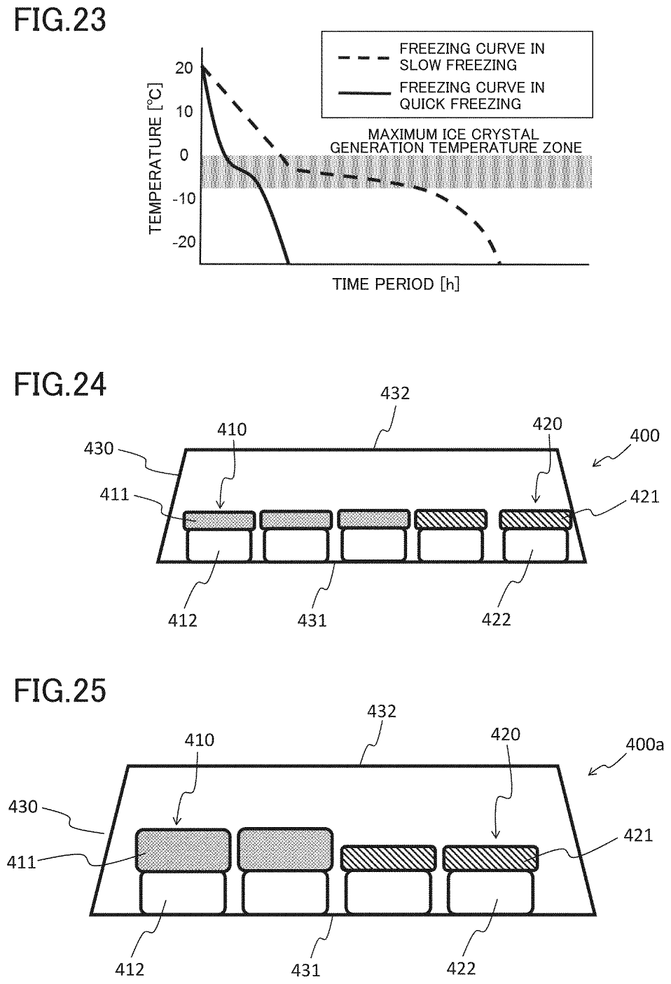

As illustrated in FIG. 23, a process of the temperature drop in freezing includes a temperature zone referred to as “maximum ice crystal generation temperature zone” in which the temperature is less likely to drop. It is known that when the food product slowly transits this temperature zone in freezing, quality of the food product deteriorates.

Hence, the food product is frozen to a temperature of −20° C. within 120 minutes from the start of freezing, making it possible to prevent the quality of the food product from deteriorating. In particular, in the case of a food product using white rice and flour, slow freezing ages the starch. As a result, the taste and texture of the food product significantly deteriorate. Thus, in freezing a food product containing a large amount of starch such as white rice and flour, for example, the food product is preferably frozen quickly from a room temperature of approximately 20° C. to a temperature of −20° C.

The defrosting step involves defrosting the frozen food product by dielectric heating with a high-frequency electric field of HF waves or VHF waves. This defrosting step may be carried out with, for example, the high-frequency heating apparatus 100 described in the first embodiment or the high-frequency heating apparatus 200 described in the second embodiment. Specifically, the food product (the product to be defrosted) is sandwiched between the upper electrode 1a and the lower electrode 1b, and a high-frequency electric field of HF waves or VHF waves is applied between the electrodes to dielectrically heat the food product. In the defrosting step, the temperature of the defrosted food product is controlled within a range from +5° C. to +60° C.

As can be seen in the freezing step, the defrosting step also includes the temperature zone referred to as “maximum ice crystal generation temperature zone” in which the temperature is less likely to rise. It is known that when a food product slowly transits this temperature zone in defrosting, quality of the food product deteriorates.

Hence, the frozen food product is quickly defrosted with the above high-frequency heating apparatus, making it possible to prevent the quality of the food product from deteriorating. In particular, in the case of a food product using white rice and flour, slow defrosting ages the starch. As a result, the taste and texture of the food product significantly deteriorate. Thus, in defrosting a food product containing a large amount of starch such as white rice and flour, the food product is preferably defrosted quickly.

A typical technique for quick defrosting involves heating with microwaves of a microwave oven. This technique, however, could cause excessive and uneven heating, and the frozen food product cannot be defrosted with its quality maintained high. Meanwhile, the defrosting with an electric field of VHF waves or HF waves from the above high-frequency heating apparatuses reduces the risks of excessive and uneven heating, making it possible to defrost the food product with its quality maintained high.

As can be seen, the food product is quickly frozen, and then defrosted by dielectric heating with an electric field of VHF waves or HF waves to a finished temperature of +5° C. to +60° C. Such a feature makes it possible to provide the food product with excellent taste and texture without using a special container or a sheet, while reducing deterioration of the food product caused by excessive heating.

Note that examples of the food product to be produced in the production method according to this embodiment include such frozen food products described in the third embodiment as the frozen sushi piece 300, the frozen sushi pack 300a, the frozen chirashi “scattered” sushi dish 300b; the frozen fish-on-rice bowl 300c; the frozen mousse cake 300d; and a frozen cheese cake 300e. These frozen food products are defrosted in the above defrosting step.

That is, the food product to be produced in the production method according to this embodiment includes the upper layer 301 and the lower layer 302 each having a different water content per unit volume. The upper layer 301 is preferably higher in water content per unit volume than the lower layer 302. When produced in the above production method, the food products can be kept from excessive and uneven heating especially in the defrosting step, and the resulting food products can be provided with excellent taste and texture.

Moreover, as to the food product to be produced in the production method according to this embodiment, the water content per unit volume of the lower layer 302 is preferably 65% or higher and 95% or lower than that of the upper layer 301. Such a feature makes it possible to more reliably keep the food product in the defrosting step from excessive and uneven heating.

Described here is an example of the dielectric heating apparatus to be used in the above defrosting step. As can be seen, the defrosting step may be carried out with, for example, the high-frequency heating apparatus 100 or the high-frequency heating apparatus 200 described as an example of the dielectric heating apparatus according to the present invention.

Each of the high-frequency heating apparatuses 100 and 200 includes: at least a pair of electrodes facing each other (i.e., the upper electrode 1a and the lower electrode 1b); the high-frequency power supply 2 supplying a high-frequency electric field of HF waves or VHF waves; and the matching circuit 3.

Such a feature makes it possible to efficiently apply the high-frequency electric field to, and defrost, the frozen food product, such that the temperature of the product is less likely to be distributed unevenly while the quality of the product is maintained high.

Moreover, the dielectric heating apparatus to be used in the defrosting step may further include a position changing mechanism changing positions of the electrodes. An example of the position changing mechanism includes the movable unit 8 of the high-frequency heating apparatus 100.

The movable unit 8 can change the position of the upper electrode 1a in dielectric heating in accordance with the size of a food product (a product to be heated). When the distance between the upper electrode 1a and a frozen food product is appropriately set, energy can be efficiently provided to the frozen food product, and the product can be defrosted in a short time period.

### Fifth Embodiment

Described next is a fifth embodiment of the present invention. The fifth embodiment describes a frozen sushi set according to an aspect of the present invention. Cited as an example of the frozen sushi set is a frozen sushi pack (a sushi assortment) including a plurality of sushi pieces. This frozen sushi pack is suitable to be defrosted by dielectric heating with a high-frequency electric field of HF waves or VHF waves. Defrosted by the dielectric heating with a high-frequency electric field of HF waves or VHF waves, the frozen sushi pack according to this embodiment can maintain its excellent texture and quality.

FIG. 24 illustrates an example of a frozen sushi pack 400 according to this embodiment. The frozen sushi pack 400 mainly includes: a container 430; and a plurality of sushi pieces 410 and 420. The container 430 includes: a tray 431; and a cover 432. Each sushi piece 410 includes: a shari rice base 412; and a neta topping 411 placed on top of the shari rice base 412. Each sushi piece 420 includes: a shari rice base 422; and a neta topping 421 placed on top of the shari rice base 422.

The shari rice base 412 and the shari rice base 422 include vinegared rice. Alternatively, in other examples, the shari rice bases may include such rice as white rice and mixed-grain rice. The neta toppings 411 and 421 include, for example, seafood. The neta toppings, however, do not have to be limited to seafood. Alternatively, the neta toppings may include such foods as vegetables, mushrooms, algae, and meat. Moreover, the neta toppings may include such food products as deep-fried seafood, omelet, vinegared mackerel, bone-less shirt rib, and a hamburger.

The sushi pieces 410 and 420 are arranged on the dray 431 of the container 430. The sushi pieces 410 and 420 are classified into a first group and a second group, using a water content (a weight) per unit volume of, for example, 60% (weight %) as a reference value. In the first group, the neta topping contains a water content below the reference value. In the second group, the neta topping contains a water content of the reference value or above.

In this embodiment, the first group includes the first sushi 410 (i.e., a sushi having a neta topping with a relatively low proportion of water). Examples of the neta topping (a first neta topping) of the first sushi 410 include: tuna (fatty cut); salmon roe, and salmon (fatty cut) (see FIG. 20). Moreover, the neta topping of the sushi piece 410 in the first group may include a food product such as vinegared mackerel.

Furthermore, the second group includes the second sushi 420 (i.e., a sushi having a neta topping with a relatively high proportion of water). Examples of the neta topping (a second neta topping) of the second sushi 420 include: tuna (red meat); salmon, shrimp (boiled), sea bream, and scallop (raw) (see FIG. 20). Moreover, the neta topping of the sushi piece 420 in the second group may include a food product such as omelet and deep-fried squid. The deep-fried squid has a water content of approximately 69%.

Note that the sushi pieces are classified into the first group and the second group not only by the kind of neta toppings but also by the water content of the neta toppings. That is, even though neta toppings are of the same kind, the neta toppings are classified into different groups if they have a different water content, depending on the portion that each neta topping belongs to.

In this embodiment, the reference value of a water content is, but not limited to, 60%. The reference value of the water content may range from 55% (weight %) to 65% (weight %).

In an example illustrated in FIG. 24, one frozen sushi pack 400 includes: three first sushi pieces 410; and two second sushi pieces 420. Hence, the frozen sushi pack 400 preferably includes the first sushi pieces 410 classified into the first group more than the second sushi pieces 420 classified into the second group. Thanks to such a feature, the first sushi pieces 410 classified into the first group can be prepared greater in total weight (e.g., in grams) than the second sushi pieces 420 classified into the second group.

When this frozen sushi pack 400 is heated (defrosted) by dielectric heating with a high-frequency electric field of HF waves or VHF waves, the first sushi pieces 410 containing a low proportion of water are heated more easily, and defrosted more quickly, than the second sushi pieces 420. Hence, the first group including the first sushi pieces 410 containing a low proportion of water is greater in total weight than the second group including the second sushi pieces 420 containing a high proportion of water. Such a feature makes it possible to narrow a difference in heating among the sushi pieces having a different water content. That is, the feature can reduce the risk of uneven heating in defrosting. In addition, the first sushi pieces 410 containing a low proportion of water are included more in the frozen sushi pack 400, so that the temperature inside the frozen sushi pack 400 is likely to rise. As a result, the frozen sushi pack 400 can be defrosted in a short time period.

In defrosting the frozen sushi pack 400, a defrosting method to be adopted is preferably based on the defrosting step of the method for producing a food product described in the above fourth embodiment. This defrosting method is preferably carried out with the high-frequency heating apparatus 100 described in the first embodiment or the high-frequency heating apparatus 200 described in the second embodiment.

In producing the frozen sushi pack 400, a production method to be adopted is preferably based on the preparation step and the freezing step of the method for producing a food product described in the above fourth embodiment. In the freezing step, in particular, the sushi pack is preferably frozen quickly to a temperature of −20° C. within 120 minutes from the start of freezing.

Thanks to such a feature, the frozen sushi pack 400 can be preserved for a long time period without food preservative. Moreover, a retail shop selling sushi packs can have a sufficient amount of stock, and thus reduce the risks of food waste and opportunity loss. Furthermore, the frozen sushi pack 400 can be defrosted for each sushi pack, and thus readily prepared. In addition, even if an external parasite is found by any chance on the sushi pack in the preparation step, the external parasite is frozen together with the sushi pack. Such a feature makes it possible to reduce growth of the external parasite, and thus development of a disease caused by the external parasite.

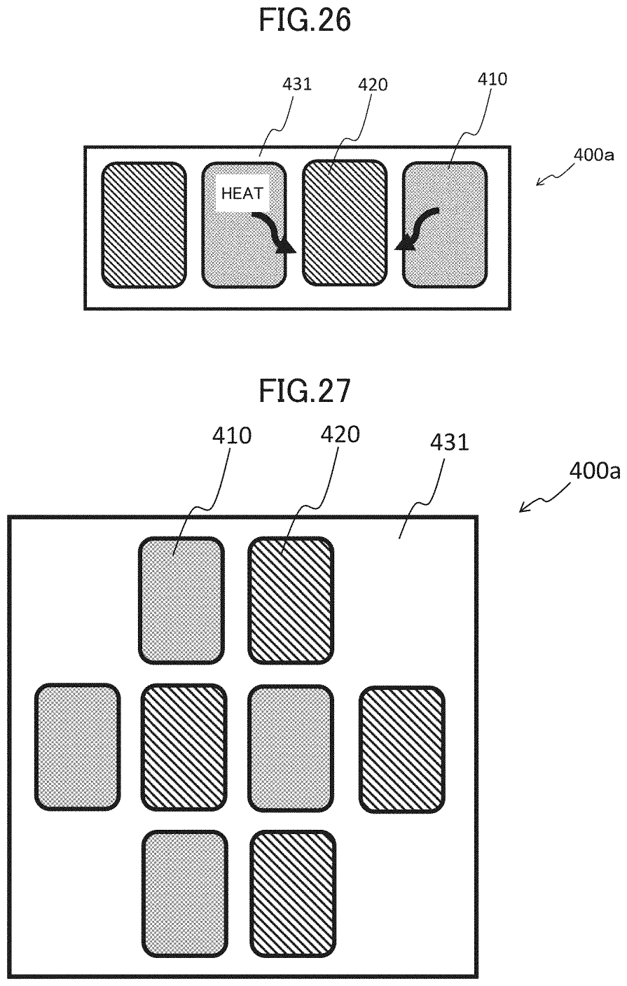

Described next are other examples of the sushi pack according to this embodiment. FIG. 25 illustrates an example of a frozen sushi pack 400a according to this embodiment. The frozen sushi pack 400a mainly includes: the container 430; and the sushi pieces 410 and 420. The container 430 includes: the tray 431; and the cover 432. Each sushi piece 410 includes: the shari rice base 412; and the neta topping 411 placed on top of the shari rice base 412. Each sushi piece 420 includes: the shari rice base 422; and the neta topping 421 placed on top of the shari rice base 422.

As can be seen in the frozen sushi pack 400, the sushi pieces included in the frozen sushi pack 400a are classified into: the first group including the first sushi piece 410 containing a low proportion of water; and the second group including the second sushi piece 420 containing a high proportion of water. Hence, the first group including the first sushi piece 410 is greater in total weight than the second group including the second sushi piece 420.

In order to achieve such features, the neta topping 411 for each of the first sushi pieces 410 in the first group is larger in amount than the neta topping 421 for each of the second sushi pieces 420 in the second group. The amount of a neta topping here is, for example, a mass of the neta topping (in grams). Alternately, in another example, the amount of a neta topping may be a volume of the neta topping (in cubic centimeters). In still another example, the neta topping 411 for each of the first sushi pieces 410 in the first group may be taller than the neta topping 421 for each of the second sushi pieces 420 in the second group.

As can be seen, in dielectric heating, the first sushi piece 410 containing a low proportion of water is heated more easily than the second sushi piece 420 containing a high proportion of water. Thus, the first sushi piece 410 and the second sushi piece 420 are provided with a different amount of neta topping. The difference makes it possible to defrost the sushi pieces in a uniform time period, contributing to simplification of the operation, and to reduction in the risk of uneven heating and the resulting improvement in quality. Such features can further reduce the risk of uneven heating in defrosting when a single sushi pack includes two or more kinds of sushi pieces each defrosting in a different time period due to a different proportion of water contained in the sushi pieces.

In FIG. 25, one frozen sushi pack 400a includes: two first sushi pieces 410; and two second sushi pieces 420. The sushi pieces 410 and 420, however, shall be provided in any given number of pieces. The first sushi pieces 410 and the second sushi pieces 420 may be the same, or different, in number of pieces. Note that the first sushi pieces 410 in the first group are greater in total weight than the second sushi pieces 420 in the second group.

Described next is an arrangement of the sushi pieces 410 and 420 in the frozen sushi packs 400 and 400a.

The frozen sushi pack 400a illustrated in FIG. 26 is shaped into a rectangle. In the frozen sushi pack 400a, the first sushi pieces 410 and the second sushi pieces 420, two each and four in total, are arranged on the tray 431. The first sushi pieces 410 and the second sushi pieces 420 are different in proportion of water contained in the neta toppings. In an example illustrated in FIG. 26, the first sushi pieces 410 containing a low proportion of water and the second sushi pieces 420 containing a high proportion of water are alternately arranged.

As illustrated, when sushi pieces each containing a different proportion of water are arranged side by side, the first sushi pieces 410, with a neta topping containing a low proportion of water and heated by defrosting, provide heat to the neighboring second sushi pieces 420 with a neta topping containing a high proportion of water so that the temperature of the neta topping is less likely to rise. Such a feature makes it possible to heat the first sushi pieces 410 and the second sushi pieces 420 to a uniformly finished temperature.

The frozen sushi pack 400a illustrated in FIG. 27 includes the first sushi pieces 410 and the second sushi pieces 420, four each and eight in total, arranged in three columns on the tray 431 shaped into a substantial square.

The frozen sushi pack 400a illustrated in FIG. 28 includes the first sushi pieces 410 and the second sushi pieces 420, four each and eight in total, arranged in two columns on the tray 431 shaped into a rectangle. In an example illustrated in FIG. 28, the first sushi pieces 410 containing a low proportion of water and the second sushi pieces 420 containing a high proportion of water are alternately arranged. In the first column, the second sushi pieces 420 and the first sushi pieces 410 are alternately arranged, starting with a second sushi piece 420 on the left of the tray 431. In the second column, the first sushi pieces 410 and the second sushi pieces 420 are alternately arranged, starting with a first sushi 410 on the left of the tray 431. In the example illustrated in FIG. 28, any sushi piece is in contact, through at least two of its side faces, with other sushi pieces containing a different proportion of water.

Specifically, the sushi pieces in the frozen sushi pack 400a include: the first neta topping a water content per unit volume of which is low; and the second neta topping a water content per unit volume of which is high. When a front-rear direction and a left-right direction of the frozen sushi pack 400a in the horizontal plane are defined as illustrated in FIG. 28, for example, the second sushi pieces 420 each having the second neta topping are arranged next to the first sushi pieces 410 each having the first neta topping, while the second sushi pieces 420 are positioned in at least two of the four neighboring positions including front, rear, left, and right of each of the first sushi pieces 410.

As illustrated, when sushi pieces each containing a different proportion of water are arranged side by side, the first sushi pieces 410, with a neta topping containing a low proportion of water and warmed by defrosting, provide heat to the neighboring second sushi pieces 420 with a neta topping containing a high proportion of water so that the temperature of the neta topping is less likely to rise. Such a feature makes it possible to heat the first sushi pieces 410 and the second sushi pieces 420 to a uniformly finished temperature. Moreover, a water content of each neta topping is focused on when an assortment and an arrangement of the sushi pieces are designed. Such an approach makes it possible to determine an assortment of the sushi pack without relying on kinds of neta toppings, stimulating appetite of consumers.

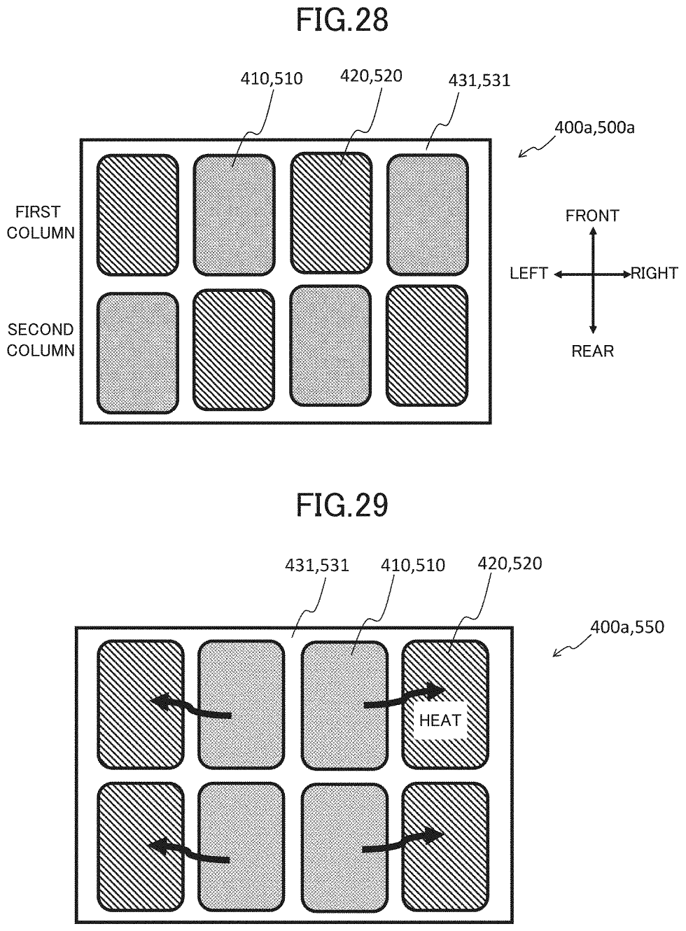

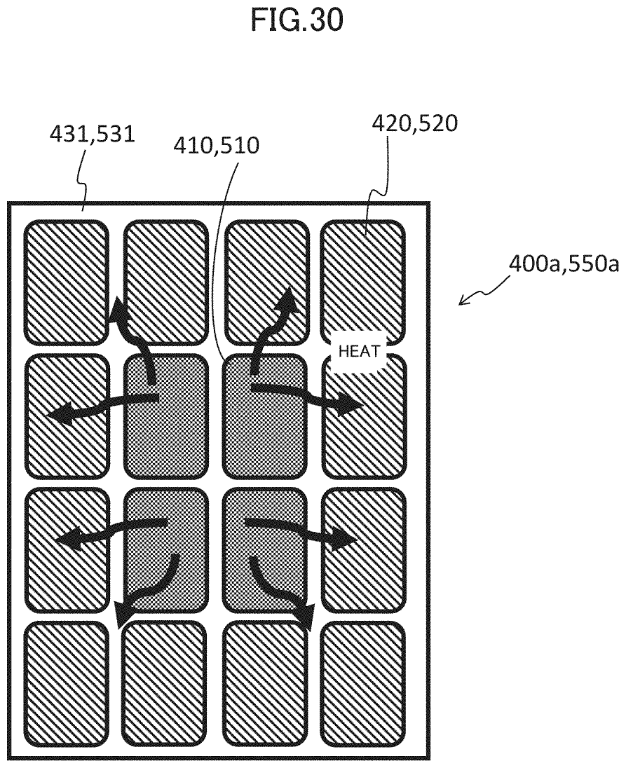

The frozen sushi pack 400a illustrated in FIG. 29 includes the first sushi pieces 410 and the second sushi pieces 420, four each and eight in total, arranged in two columns on the tray 431 shaped into a rectangle. In an example illustrated in FIG. 29, the second sushi pieces 420 having a neta topping containing a high proportion of water arc arranged closer to an end of the tray 431, and the first sushi pieces 410 having a neta topping containing a low proportion of water are arranged in a center of the tray 431.

As can be seen, the first sushi pieces 410, containing a low proportion of water and more likely to be warmed, are arranged in the center of the tray 431, making it possible to transmit the heat from the first sushi pieces 410 to the neighboring second sushi pieces 420. Such a feature makes it possible to efficiently transfer output of the defroster into defrosting heat.

The frozen sushi pack 400a illustrated in FIG. 30 includes sixteen sushi pieces in total, that is, four first sushi pieces 410 and twelve second sushi pieces 420. In an example illustrated in FIG. 30, the second sushi pieces 420 having a neta topping containing a high proportion of water are arranged closer to the four edges of the tray 431, and the first sushi pieces 410 having a neta topping containing a low proportion of water are arranged in a center of the tray 431.

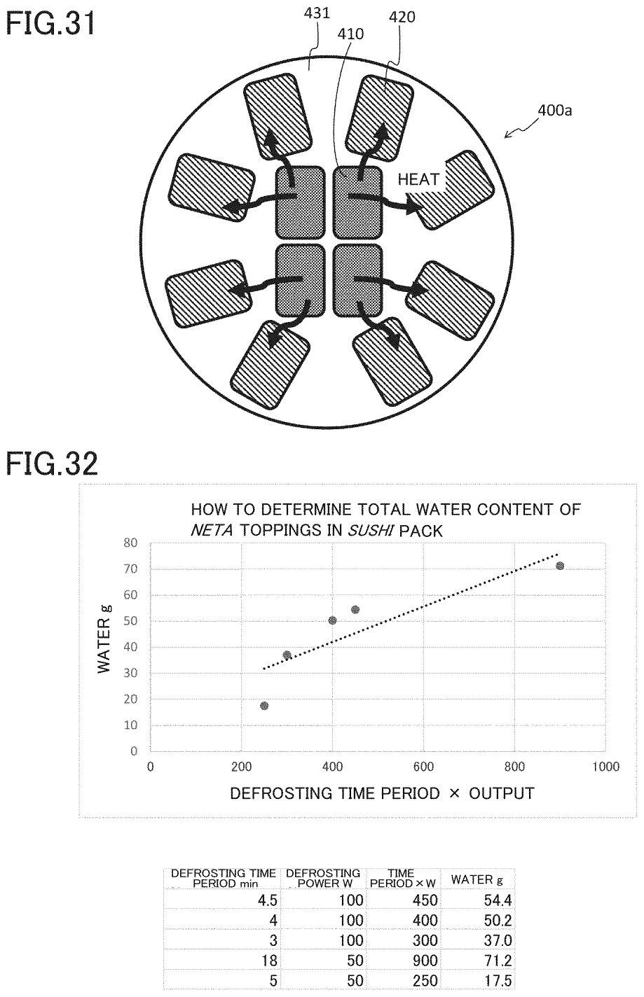

The frozen sushi pack 400a illustrated in FIG. 31 includes twelve sushi pieces in total, that is, four first sushi pieces 410 and eight second sushi pieces 420. In an example illustrated in FIG. 31, the second sushi pieces 420 having a neta topping containing a high proportion of water are arranged closer to the outer circumference (i.e., closer to an end) of the tray 431 shaped circularly, and the first sushi pieces 410 having a neta topping containing a low proportion of water are arranged in a center of the tray 431.

### Examples

Examples below show the studies of the frozen sushi pack 400 including: the first sushi pieces 410 having a neta topping with a water content of 50%; and the second sushi pieces 420 having a neta topping with a water content of 80%. In the studies, the sushi pieces were dielectrically heated while a proportion of the sushi pieces in each group was changed in various manner, and were evaluated how well they were finished after the end of the heating. The total numbers of the sushi pieces included in the frozen sushi pack 400 were three, four, five, six, seven, eight, nine, ten, fifteen, and twenty.

The results of the evaluations are shown in Tables 1 to 3 below. The criteria for the evaluation results in the tables are denoted as follows:

Good: Most suitable. High quality, and defrosted quickly.

Fair: Can be defrosted, but poor heat efficiency, and takes some time to defrost. Needs another approach (e.g., changing arrangement).

Poor: Barely defrostable, but the resulting quality is unstable.

Note that the tables below also show the results of the experiments on frozen sushi packs including sushi pieces that belong to a single group alone. These frozen sushi packs have marked the result “Good.”

TABLE 1
Total: 20

| First | Second | Proportion of | Evaluation |
|---|---|---|---|
| Gr. | Gr. | First Gr. (%) | Result |
| 0 | 20 | 0.0 | Good |
| 1 | 19 | 5.0 | Poor |
| 2 | 18 | 10.0 | Poor |
| 3 | 17 | 15.0 | Poor |
| 4 | 16 | 20.0 | Fair |
| 5 | 15 | 25.0 | Good |
| 6 | 14 | 30.0 | Good |
| 7 | 13 | 35.0 | Good |
| 8 | 12 | 40.0 | Good |
| 9 | 11 | 45.0 | Good |
| 10 | 10 | 50.0 | Good |
| 11 | 9 | 55.0 | Good |
| 12 | 8 | 60.0 | Good |
| 13 | 7 | 65.0 | Good |
| 14 | 6 | 70.0 | Good |
| 15 | 5 | 75.0 | Good |
| 16 | 4 | 80.0 | Fair |
| 17 | 3 | 85.0 | Poor |
| 18 | 2 | 90.0 | Poor |
| 19 | 1 | 95.0 | Poor |
| 20 | 0 | 100.0 | Good |

TABLE 2

| | | | |
|---|---|---|---|
| First | Second | Proportion of | Evaluation |
| Gr. | Gr. | First Gr. (%) | Result |

Total: 15

| | | | |
|---|---|---|---|
| 0 | 15 | 0.0 | Good |
| 1 | 14 | 6.7 | Poor |
| 2 | 13 | 13.3 | Poor |
| 3 | 12 | 20.0 | Fair |
| 4 | 11 | 26.7 | Good |
| 5 | 10 | 33.3 | Good |
| 6 | 9 | 40.0 | Good |
| 7 | 8 | 46.7 | Good |
| 8 | 7 | 53.3 | Good |
| 9 | 6 | 60.0 | Good |
| 10 | 5 | 66.7 | Good |
| 11 | 4 | 73.3 | Good |
| 12 | 3 | 80.0 | Fair |
| 13 | 2 | 86.7 | Poor |
| 14 | 1 | 93.3 | Poor |
| 15 | 0 | 100.0 | Good |

Total: 10

| | | | |
|---|---|---|---|
| 0 | 10 | 0.0 | Good |
| 1 | 9 | 10.0 | Poor |
| 2 | 8 | 20.0 | Fair |
| 3 | 7 | 30.0 | Good |
| 4 | 6 | 40.0 | Good |
| 5 | 5 | 50.0 | Good |
| 6 | 4 | 60.0 | Good |
| 7 | 3 | 70.0 | Good |
| 8 | 2 | 80.0 | Fair |
| 9 | 1 | 90.0 | Poor |
| 10 | 0 | 100.0 | Good |

Total: 9

| | | | |
|---|---|---|---|
| 0 | 9 | 0.0 | Good |
| 1 | 8 | 11.1 | Poor |
| 2 | 7 | 22.2 | Fair |
| 3 | 6 | 33.3 | Good |
| 4 | 5 | 44.4 | Good |
| 5 | 4 | 55.6 | Good |
| 6 | 3 | 66.7 | Good |
| 7 | 2 | 77.8 | Fair |
| 8 | 1 | 88.9 | Poor |
| 9 | 0 | 100.0 | Good |

TABLE 3

| | | | |
|---|---|---|---|
| First | Second | Proportion of | Evaluation |
| Gr. | Gr. | First Gr. (%) | Result |

Total: 8

| | | | |
|---|---|---|---|
| 0 | 8 | 0.0 | Good |
| 1 | 7 | 12.5 | Fair |
| 2 | 6 | 25.0 | Good |
| 3 | 5 | 37.5 | Good |
| 4 | 4 | 50.0 | Good |
| 5 | 3 | 62.5 | Good |
| 6 | 2 | 75.5 | Good |
| 7 | 1 | 87.5 | Fair |
| 8 | 0 | 100.0 | Good |

Total: 7

| | | | |
|---|---|---|---|
| 0 | 7 | 0.0 | Good |
| 1 | 6 | 14.3 | Fair |
| 2 | 5 | 28.6 | Good |
| 3 | 4 | 42.9 | Good |
| 4 | 3 | 57.1 | Good |
| 5 | 7 | 71.4 | Good |
| 6 | 1 | 85.7 | Fair |
| 7 | 0 | 100.0 | Good |

Total: 6

| | | | |
|---|---|---|---|
| 0 | 6 | 0.0 | Good |
| 1 | 5 | 16.7 | Fair |
| 2 | 4 | 33.3 | Good |
| 3 | 3 | 50.0 | Good |
| 4 | 2 | 66.7 | Good |
| 5 | 1 | 83.3 | Fair |
| 6 | 0 | 100.0 | Good |

Total: 5

| | | | |
|---|---|---|---|
| 0 | 5 | 0.0 | Good |
| 1 | 4 | 20.0 | Fair |
| 2 | 3 | 40.0 | Good |
| 3 | 2 | 60.0 | Good |
| 4 | 1 | 80.0 | Fair |
| 5 | 0 | 100.0 | Good |

Total: 4

| | | | |
|---|---|---|---|
| 0 | 4 | 0.0 | Good |
| 1 | 3 | 25.0 | Good |
| 2 | 2 | 50.0 | Good |
| 3 | 1 | 75.0 | Good |
| 4 | 0 | 100.0 | Good |

Total: 3

| | | | |
|---|---|---|---|
| 0 | 3 | 0.0 | Good |
| 1 | 2 | 33.3 | Good |
| 2 | 1 | 66.7 | Good |
| 3 | 0 | 100.0 | Good |

The above results have found out that sushi pieces are finished “Good” at the end of the defrosting when the first sushi pieces 410 classified into the first group ranges account for 25% to 75% of all the sushi pieces included in the frozen sushi pack 400.

Method for Defrosting Frozen Sushi Pack

Described next is a method for defrosting the frozen sushi pack 400 according to this embodiment. Note that this method can be applicable to the frozen sushi packs 400a, 400b, and 400c other than the frozen sushi pack 400.

The frozen sushi pack 400 can be defrosted in accordance with the defrosting step of the method for producing a food product described in the above fourth embodiment. When defrosted, the frozen sushi pack 400 is dielectrically heated with a high-frequency electric field of HF waves or VHF waves. This defrosting method may be carried out with, for example, such a defroster as the high-frequency heating apparatus 100 described in the first embodiment, or the high-frequency heating apparatus 200 described in the second embodiment. Specifically, the frozen sushi pack 400 (a product to be defrosted) is sandwiched between the upper electrode 1a and the lower electrode 1b, and a high-frequency electric field of HF waves or VHF waves is applied between the electrodes to dielectrically heat the frozen sushi pack 400.

In defrosting the frozen sushi pack 400, a quick defrosting technique is preferably selected to finish the defrosting in the shortest time period possible.

A typical technique for quick defrosting involves heating with microwaves of a microwave oven. This technique, however, could cause excessive and uneven heating, and the frozen food product cannot be defrosted with its quality maintained high. Meanwhile, the defrosting with an electric field of VHF waves or HF waves from the above high-frequency heating apparatuses reduces the risks of excessive and uneven heating, and draining juice, making it possible to defrost the food product with its quality maintained high.

Described here is an example of the dielectric heating apparatus to be used in defrosting the frozen sushi pack 400. As can be seen, the defrosting may be carried out with, for example, the high-frequency heating apparatus 100 or the high-frequency heating apparatus 200 described as an example of the dielectric heating apparatus according to the present invention.

Each of the high-frequency heating apparatuses 100 and 200 includes: at least a pair of electrodes facing each other (i.e., the upper electrode 1a and the lower electrode 1b); the high-frequency power supply 2 supplying a high-frequency electric field of HF waves or VHF waves; and the matching circuit 3.

Such a feature makes it possible to efficiently apply the high-frequency electric field to the frozen sushi pack 400, so that the sushi can be quickly defrosted while its quality maintained high with little uneven temperature distribution.

Moreover, the dielectric heating apparatus to be used in the defrosting may further include a position changing mechanism changing positions of the electrodes. An example of the position changing mechanism includes the movable unit 8 of the high-frequency heating apparatus 100.

The movable unit 8 can change the position of the upper electrode 1a in dielectric heating in accordance with the size of the frozen sushi pack 400. When the distance between the upper electrode 1a and a frozen food product is appropriately set, energy can be efficiently provided to the frozen food product, and the product can be defrosted in a short time period.

Note that a total water content of the neta toppings of the sushi pieces included in the frozen sushi pack 400 is proportional to a product of an output power (an output wattage rating) of the defroster and a defrosting time period to be required to defrost the frozen sushi pack 400 in a desired state. Hence, the defrosting time period in defrosting and the output power of the defroster are determined preferably on the basis of the total water content of the neta toppings of the sushi pieces included in the frozen sushi pack 400.

FIG. 32 illustrates a total water content (g) of the neta toppings of the sushi pieces in a sushi pack, a defrosting time period (min.) to be required for defrosting the sushi pack, a defrosting power (W), and a product of the defrosting time period and the defrosting power (time period×W). As illustrated in this graph, the product of the defrosting time period and the defrosting power is substantially proportional to the total water content of the neta toppings included in the sushi pack.

Hence, an assortment (e.g., a total water content (g) of a neta topping of each sushi piece) of the sushi pieces included in the frozen sushi pack 400 is preferably determined, with reference to a graph in FIG. 32, in accordance with the specifications (e.g., a set defrosting time period (min.) and a defrosting power (W)) of the defroster (e.g., the high-frequency heating apparatus 100 or the high-frequency heating apparatus 200) to be used for defrosting.

As an example, when the defroster has a button preset at such values as “100 W, 5 min.”, water contents of neta toppings may be adjusted with reference to the graph in FIG. 32, so that the total water content (g) of the neta toppings in the sushi pack 400 may be approximately 50 g. The defroster is readily operated with a setting button of the defroster, making it possible to finish the defrosted sushi in a good condition.

As an alternative technique, an indication of the defrosting time period can be determined from the defrosting power and the total water content of the neta toppings in the frozen sushi pack 400. In this case, the defrosting time period is set to suit the neta toppings, making it possible to reduce the risks of excessive heating and insufficient defrosting of the neta toppings.

Other Modifications

Described below are other examples of the sushi pieces included in the frozen sushi pack 400.

Other than the neta toppings 411 and 421, and the shari rice bases 412 and 422, the sushi pieces 410 and 420 in the frozen sushi pack 400 may include a seaweed sheet as an ingredient. Moreover, in the first sushi piece 410 and the second sushi piece 420 described above, the neta topping is positioned on top of the shari rice base. The neta topping and the shari rice, however, may be positioned in any given manner.

In the case where a sushi piece includes a shari rice base, a neta topping, and a seaweed sheet, the neta topping may be positioned inside the shari rice base, and the seaweed sheet may be positioned outside the shari rice base, just like a rolled “nori-maki” sushi. Alternatively, the neta topping and the seaweed sheet may be positioned inside the shari rice base.

Furthermore, to meet the needs of consumers, the proportion of the shari rice base and the neta topping can be changed as appropriate. In addition, a frozen sushi pack according to this embodiment may be combined with a soup to form a set of frozen food products. In this case, for example, the frozen sushi pack is positioned above and the soup is positioned below. As seen in the high-frequency heating apparatus 100 or the high-frequency heating apparatus 200, for example, the electrodes of a defroster to be used for defrosting include an upper electrode and a lower electrode.

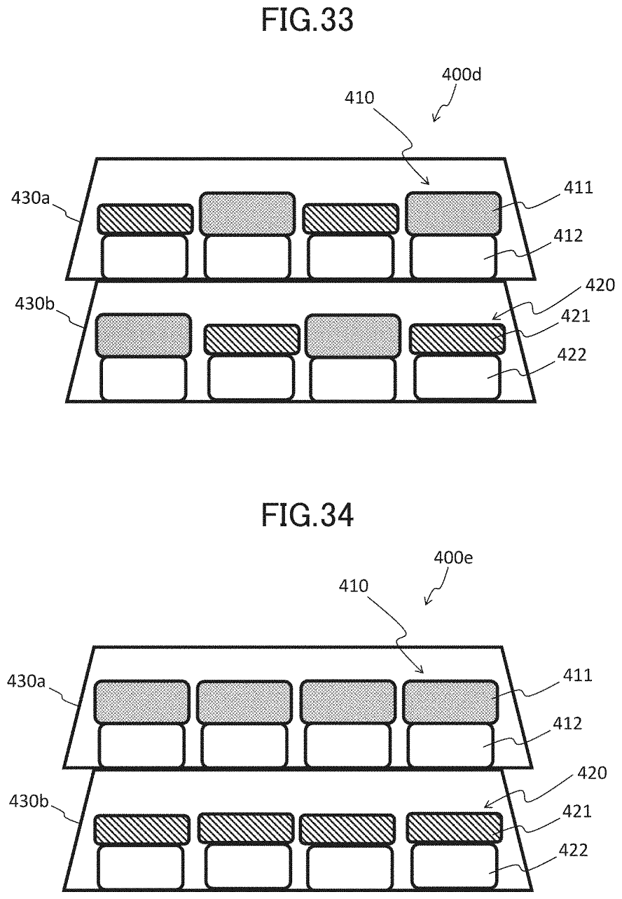

FIGS. 33 to 35 illustrate examples of frozen sushi packs each including a plurality of containers stacked on top of another.

A frozen sushi pack 400d illustrated in FIG. 33 includes two containers, namely 430a and 430b, stacked on top of another. In each of the containers 430a and 430b, the sushi pieces 410 and 420 are arranged. As can be seen in the frozen sushi pack 400, the sushi pieces included in the frozen sushi pack 400d are classified into: the first group including the first sushi pieces 410 containing a low proportion of water, and the second group including the second sushi pieces 420 containing a high proportion of water.

In the upper container 430a illustrated in FIG. 33 as an example, the second sushi pieces 420 and the first sushi pieces 410 are alternately arranged, starting with a second sushi piece 420 on the left of the tray. In the lower container 430b, the first sushi pieces 410 and the second sushi pieces 420 are alternately arranged, starting with a first sushi piece 420 on the left of the tray.

As can be seen, the sushi pieces each containing a different proportion of water are vertically arranged. This arrangement allows the heat to equally transmit between vertically arranged sushi pieces, and, as a result, the sushi pieces are finished to a uniform temperature. Such a feature makes it possible to determine an assortment sushi pieces in the sushi pack without relying on kinds of neta toppings, readily satisfying tastes of consumers.

A frozen sushi pack 400e illustrated in FIG. 34 includes two containers, namely the 430a and the 430b, stacked on top of another. In the container 430a, the sushi pieces 410 are arranged, and, in the container 430b, the sushi pieces 420 are arranged. As can be seen in the frozen sushi pack 400, the sushi pieces included in the frozen sushi pack 400e are classified into: the first group including the first sushi pieces 410 containing a low proportion of water, and the second group including the second sushi pieces 420 containing a high proportion of water.

More specifically, arranged in the container 430a above are the first sushi pieces 410 containing a low proportion of water. Arranged in the container 430b below are the second sushi pieces 420 containing a high proportion of water.

As can be seen, the two containers 430a and 430b are stacked on top of another, and for each of the containers, the sushi pieces contain a different proportion of water. This arrangement allows the heat to equally transmit between vertically arranged sushi pieces, and, as a result, the sushi pieces are finished to a uniform temperature. Such a feature makes it possible to determine an assortment of sushi pieces in the sushi pack without relying on kinds of neta toppings, readily satisfying tastes of consumers.

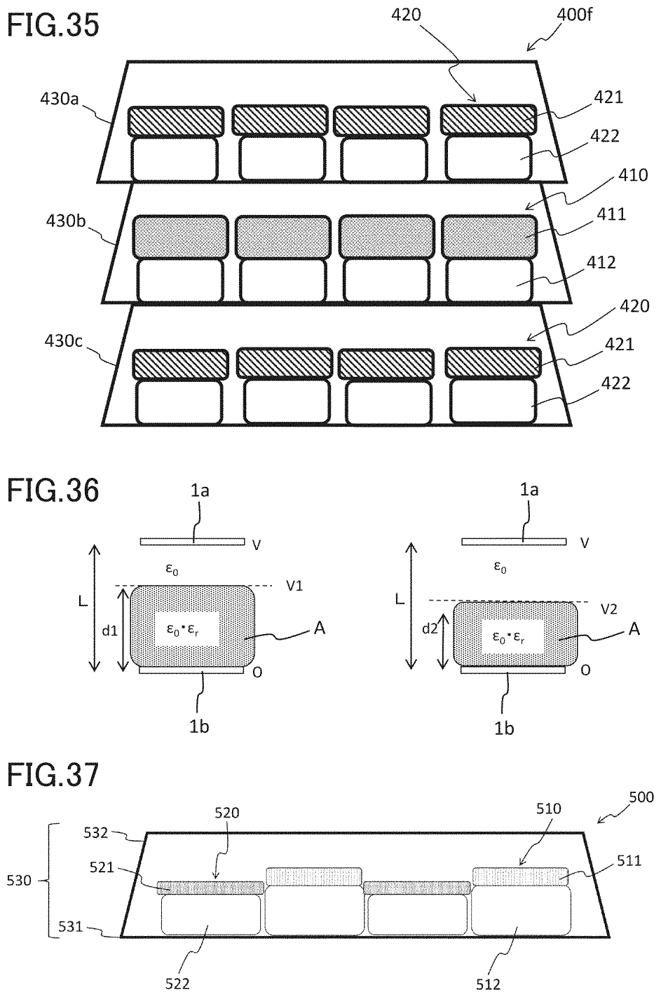

A frozen sushi pack 400f illustrated in FIG. 35 includes three containers, namely the 430a, the 430b, and a 430c stacked on top of another. In each of the containers 430a, 430b, and 430c, the sushi pieces 410 and 420 are arranged. As can be seen in the frozen sushi pack 400, the sushi pieces included in the frozen sushi pack 400f are classified into: the first group including the first sushi pieces 410 containing a low proportion of water; and the second group including the second sushi pieces 420 containing a high proportion of water.

More specifically, arranged in the container 430b on the top and in the container 430c on the bottom are the second sushi pieces 420 containing a high proportion of water. Arranged in the container 430b in the middle are the first sushi pieces 410 containing a low proportion of water.

As can be seen, the three containers 430a, 430b, and 430c are stacked on top of another in the stated order, and for each of the containers, the sushi pieces contain a different proportion of water. This arrangement allows the heat to equally transmit between vertically arranged sushi pieces, and, as a result, the sushi pieces are finished to a uniform temperature. Such a feature makes it possible to determine an assortment in the sushi pack without relying on kinds of neta toppings, readily satisfying tastes of consumers.

Summary of Fifth Embodiment

The frozen sushi pack 400 according to this embodiment includes two or more kinds of sushi pieces containing a different proportion of water (i.e., the sushi piece 410 and the sushi piece 420). The sushi pieces 410 and 420 are classified into a first group and a second group, using a water content (a weight) per unit volume ranging from 55% (weight %) to 65% (weight %) as a reference value. In the first group, the neta topping contains a water content below the reference value. In the second group, the neta topping contains a water content of the reference value or above. The first sushi pieces 410 classified into the first group are greater in total weight (e.g., in grams) than the second sushi pieces 420 classified into the second group.

Hence, the first sushi pieces 410, containing a low proportion of water and more likely to be heated, are greater in the amount of neta toppings than the second sushi pieces 420 containing a high proportion of water and less likely to be heated. Such a feature makes it possible to extend the time period in which all the sushi pieces are warmed, and to uniformly raise the temperature of each of the sushi pieces.

Moreover, when an arrangement of the sushi pieces is designed for the frozen sushi pack 400 according to this embodiment, effects of heat transfer among the sushi pieces are taken into consideration. Such an approach allows the heat generated in, for example, the first sushi pieces 410 to transfer to the neighboring second sushi pieces 420, making it possible to efficiently transfer output of the defroster into defrosting heat. Hence, unlike the method disclosed in Patent Document 3 (Japanese Unexamined Patent Application Publication No. H10-056995), for example, the approach can provide sushi pieces at an optimum temperature through adjustment in the amount of neta toppings alone without using a container, having water therein, to be placed above a sushi container.

That is, when the sushi pieces are defrosted by dielectric heating, the frozen sushi pack 400 according to this embodiment can provide sushi pieces with their texture and quality maintained without changing the containers and adding extra operations.

Moreover, the frozen sushi pack 400 according to this embodiment can reduce the risk of uneven temperature distribution in defrosting without complex mechanisms in, and control of, the defroster. In addition, by the assortment of sushi pieces in the frozen sushi 400, the defrosting temperature can be controlled to a certain degree. Such a feature makes it possible to defrost the sushi pieces in a uniform time period, and to simplify the operation and the control sequence of the defroster.

When an assortment and an arrangement of the sushi pieces are designed, a water content of each neta topping is focused on. Such an approach makes it possible to determine the assortment of the sushi pieces in a sushi pack without relying on kinds of neta toppings. This approach makes it possible to provide a sushi pack with various kinds of neta toppings, stimulating appetite of consumers. Moreover, the approach allows for adjustment of temperature of shari rice bases and neta toppings, making it possible to control texture of the sushi pieces and to increase options of the texture in accordance with tastes of consumers.

### Sixth Embodiment

Described next is a sixth embodiment of the present invention. The sixth embodiment describes a frozen sushi set according to an aspect of the present invention. Cited here as an example of the frozen sushi set is a frozen sushi pack (a sushi assortment) including a plurality of sushi pieces. This frozen sushi pack is defrosted by dielectric heating with a high-frequency electric field of HF waves or VHF waves.

This embodiment focuses on a height of the sushi pieces included in the frozen sushi pack, and involves appropriately adjusting an arrangement of the sushi pieces in the container, in accordance with the height of each sushi piece. Moreover, this embodiment involves adjusting rates of water contents and mass densities among the sushi pieces, in accordance with rates of the heights among the sushi pieces. Hence, the frozen sushi pack according to this embodiment maintains excellent texture and quality when defrosted by dielectric heating.

Height and Uneven Temperature Distribution of Product to be Heated

Prior to the description of the frozen sushi pack according to this embodiment, described as a precondition of the frozen sushi pack is uneven temperature distribution due to a difference in height among products to be heated (i.e., sushi pieces).

As illustrated in FIG. 36, products A to be heated, each having a height of d1 and d2 (d1>d2) and substantially the same permittivity, are placed between plate-like electrodes (the electrodes 1a and 1b) arranged in parallel with each other at a distance L. When, a voltage V is applied between the plate-like electrodes, the products A receive respective voltages V1 and V2. Here, a field strength of the products A is obtained by voltage/height. When the products A have respective field strengths of (V1/d1) and (V2/d2), a relationship of (V1/d1)>(V2/d2) holds. In dielectric heating, a subject with a greater field strength is more likely to be heated. Hence, the product A with a height of d1 is likely to be heated. That is, the temperature is likely to distribute unevenly between the products having the respective heights of d1 and d2.

The same goes for the case when the products A are sushi pieces. When dielectrically heated between the upper electrode 1a and the lower electrode 1b shaped into a flat plate and arranged in parallel with each other, a taller sushi is heated more quickly. That is, when sushi pieces with a different height are dielectrically heated simultaneously, the temperature of a taller sushi piece rises more quickly, causing uneven temperature distribution among the sushi pieces.

Frozen Sushi Pack 500

FIG. 37 illustrates an example of a frozen sushi pack 500 according to this embodiment. The frozen sushi pack 500 mainly includes: a container 530; and a plurality of sushi pieces 510 and 520. The container 530 includes: a tray 531; and a cover 532. Each sushi piece 510 includes: a shari rice base 512; and a neta topping 511 placed on top of the shari rice base 512. Each sushi piece 520 includes: a shari rice base 522; and a neta topping 521 placed on top of the shari rice base 522.

The shari rice base 512 and the shari rice base 522 include vinegared rice. Alternatively, in other examples, the shari rice bases may include such rice as white rice and mixed-grain rice. The neta toppings 511 and 521 include, for example, seafood. The neta toppings, however, do not have to be limited to seafood. Alternatively, the neta toppings may include such foods as vegetables, mushrooms, algae, and meat. Moreover, the neta toppings may include such food products as deep-fried seafood, omelet, vinegared mackerel, bone-less short rib, and a hamburger.

The sushi pieces 510 and 520 are arranged on the dray 531 of the container 530. The sushi pieces 510 and 520 are classified into a first group and a second group with a predetermined reference value. The sushi pieces in the first group have a height greater than this predetermined value, and the sushi pieces in the second group have a height of this predetermined value or smaller. The sushi pieces 510 and 520 in the frozen sushi pack 500 according to this embodiment include at least two kinds of sushi pieces having a different height.

Note that the height of each sushi piece is a distance between the surface of the tray 531 of the container 530 and the top surface of the sushi piece. Moreover, the height of each sushi piece is the sum of the heights of the shari rice base and the neta topping. Hence, the heights of sushi pieces vary by a difference in height between the neta toppings, even if the shari rice bases are the same in height. Furthermore, even if sushi pieces have the same kind of neta toppings, the heights of the sushi pieces may vary if the neta toppings are different in size.

In this embodiment, the first group includes the first sushi 510 (i.e., a relatively tall sushi). The second group includes the second sushi 520 (i.e., a relatively short sushi).

Note that the classification of the sushi pieces into the first group and the second group is based on a predetermined reference value. The predetermined reference value can be determined in accordance with any given selection criteria. An example of the predetermined reference value may be the average height of all the sushi pieces included in the frozen sushi pack 500. Another example of the predetermined reference value may be a ratio of the height of a sushi piece to the distance between the two plate-like electrodes (e.g., the upper electrode 1a and the lower electrode 1b) of the defroster to be used for defrosting, that is, for example, any given value ranging from 50% to 70% of the inter-electrode distance D, and, more specifically, 60% of the inter-electrode distance D. Still another example of the predetermined reference value may be of approximately 80% (any given value from 75% to 85%) of a height dmax of the tallest sushi piece.

In the frozen sushi pack 500 according to this embodiment, the arrangement of the sushi pieces 510 and 520, each having a different height, is determined depending on the difference in height. When sushi pieces in the tall group (i.e., sushi pieces in the first group) alone or sushi pieces in the short group (i.e., sushi pieces in the second group) alone are arranged together, the heat does not transfer among the sushi pieces within the tall group or within the short group. Hence, the temperature distributes unevenly among all the sushi pieces in a frozen sushi pack.

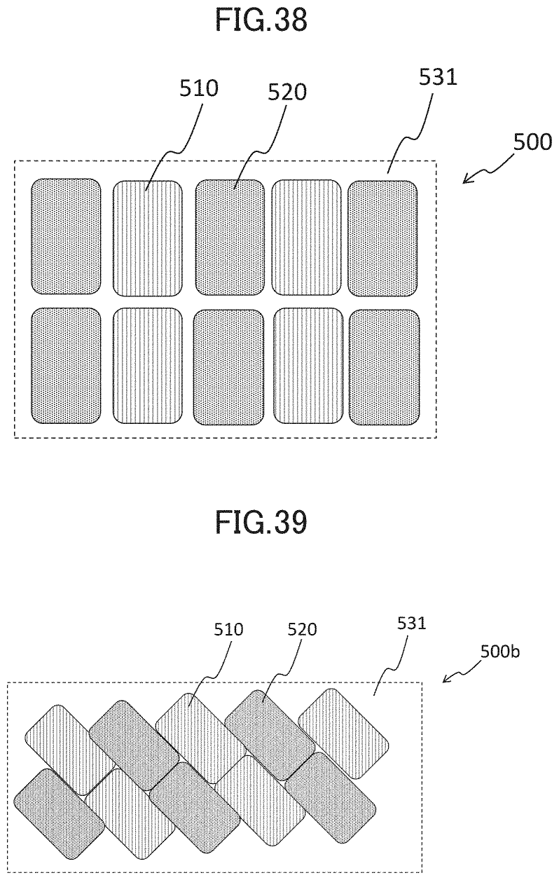

In the frozen sushi pack 500 in FIG. 38 according to this embodiment, the tall first sushi pieces 510 and the short second sushi pieces 520 are alternately arranged when viewed from above. The sushi pieces with a different height are arranged side by side, with their longitudinal sides facing each other. Such an arrangement promotes heat transfer contributing to uniform temperature distribution among the sushi pieces, reducing uneven temperature distribution in defrosting.

Note that an example of the alternate arrangement of the first sushi pieces 510 and the second sushi pieces 520 includes the arrangement in the frozen sushi pack 500a illustrated in FIG. 28. In the example illustrated in FIG. 28, the first sushi pieces 510 and the second sushi pieces 520 are staggered. In such an arrangement, the sushi pieces with a different height are arranged side by side not only with their longitudinal sides but also with their transverse sides facing each other. Such an arrangement allows the sushi pieces with a different temperature to be in contact in larger areas. This arrangement further promotes heat transfer contributing to uniform temperature distribution among the sushi pieces, reducing uneven temperature distribution in defrosting. In addition, the arrangement improves an overall appearance of the sushi pieces.

In addition, another example of the alternate arrangement of the first sushi pieces 510 and the second sushi pieces 520 includes an arrangement in a frozen sushi pack 500b illustrated in FIG. 39. In the example illustrated in FIG. 39, the sushi pieces are arranged at angle to the shape of the tray 531 when viewed from above, and the first sushi pieces 510 and the second sushi pieces 520 are alternately arranged. The sushi pieces arranged at angle remind consumers of an assortment of high-end sushi presented in a sophisticated manner. Moreover, the sushi pieces with a different height are arranged side by side, with their longitudinal sides facing each other. Such an arrangement promotes heat transfer contributing to uniform temperature distribution among the sushi pieces, reducing uneven temperature distribution in defrosting.

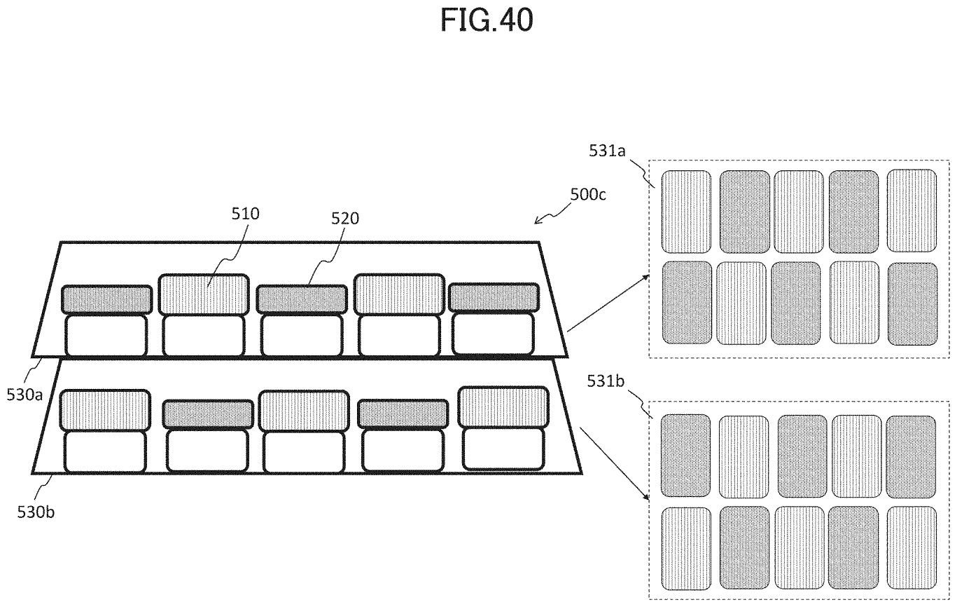

Still another example of the alternate arrangement of the first sushi pieces 510 and the second sushi pieces 520 includes an arrangement in a frozen sushi pack 500c illustrated in FIG. 40. In the example illustrated in FIG. 40, two containers 530a and 530b are stacked on top of another. The sushi pieces arranged on a tray 531a of the container 530a and on a tray 531b of the container 530b are staggered as illustrated in FIG. 28. FIG. 40 shows on the right the two trays 531a and 531b one of which is turned around at 180 degrees. When these trays are stacked on top of another as shown in FIG. 40 on the left, the tall sushi pieces 510 and the short sushi pieces 520 are vertically arranged such that the total height of a first sushi piece 510 and a second sushi piece 520 vertically arranged is the same anywhere in the frozen sushi pack 500c. Such an arrangement reduces uneven temperature distribution among the sushi pieces in defrosting.

Uneven Temperature Distribution Inside Product to be Heated

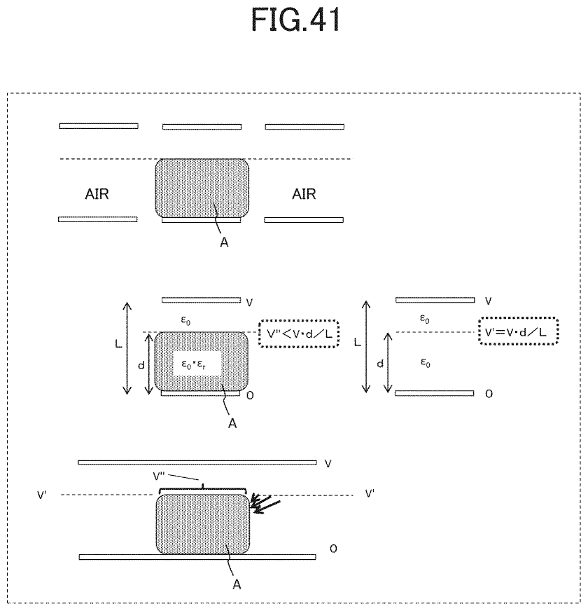

Described next is uneven temperature distribution that could occur inside a product to be heated in dielectric heating, with reference to FIG. 41. When the product A with a height d is disposed between a pair of plate-like electrodes arranged in parallel with each other at the distance L, and the voltage V is applied between the plate-like electrodes, a relationship of V″<V′ holds where V″ represents a voltage to be applied to the product A, and V′ represents a voltage observed at the height d in a region containing only the air, without the product A. Here, found at a corner of the top face of the product is a horizontal electric field caused by a horizontal potential difference (V′−V″), as well as a vertical electric field caused by an inter-electrode voltage. Such a concentration of the electric fields causes the corner to be heated more readily than other portions of the product. That is, the temperature is likely to distribute unevenly inside the product.

When a plurality of sushi pieces in a frozen sushi pack are observed as a single chunk, opposing ends of the chunk are likely to be heated. Hence, when the sushi pieces are arranged, sushi pieces at the opposing ends are likely to be heated. Moreover, in the case of the arrangement illustrated in FIG. 37, disposed at the right end is a tall first sushi 510. This means that a sushi piece likely to be heated is in a position likely to be heated. Such an arrangement promotes the rise in the temperature of the sushi piece at the right end further than other sushi pieces, encouraging uneven temperature distribution among all the sushi pieces.

Frozen Sushi Pack 550

In order to reduce the uneven temperature distribution, described below is an example of an arrangement of the sushi pieces with a different height. As can be seen, when arranged at ends of all the sushi pieces, tall sushi pieces are likely to be heated significantly, increasing the risk of uneven temperature distribution among all the sushi pieces in a sushi pack.

Hence, the first sushi pieces 510 classified into the first group are preferably arranged in a center of the tray 531. Moreover, the second sushi pieces 520 classified into the second group are preferably arranged on an outer edge (at an end) of the tray 531.

An example of such an arrangement includes the arrangement in the frozen sushi pack 550 illustrated in FIG. 29. In this arrangement example, the sushi pieces are arranged so that the second sushi pieces 520, shaped into a cuboid, have a longitudinal side face positioned to ends of the tray 531. Thanks to the arrangement, the side faces of the second sushi pieces 520 to the ends of the tray 531 are larger in area than the side faces of the first sushi pieces 510 to ends of the tray 531. That is, when the sushi set is observed as a whole, the second sushi pieces 520, which are less likely to be heated, are arranged more at the ends.

Compared with the frozen sushi pack 550, if more sushi pieces are arranged while short second sushi pieces 520 are included in a larger proportion, the sushi pieces can be arranged as seen in the frozen sushi pack 550a illustrated in FIG. 30. Hence, the short second sushi pieces 520 are arranged on outer edges to be readily heated, making it possible to reduce uneven heat distribution among all the sushi pieces.

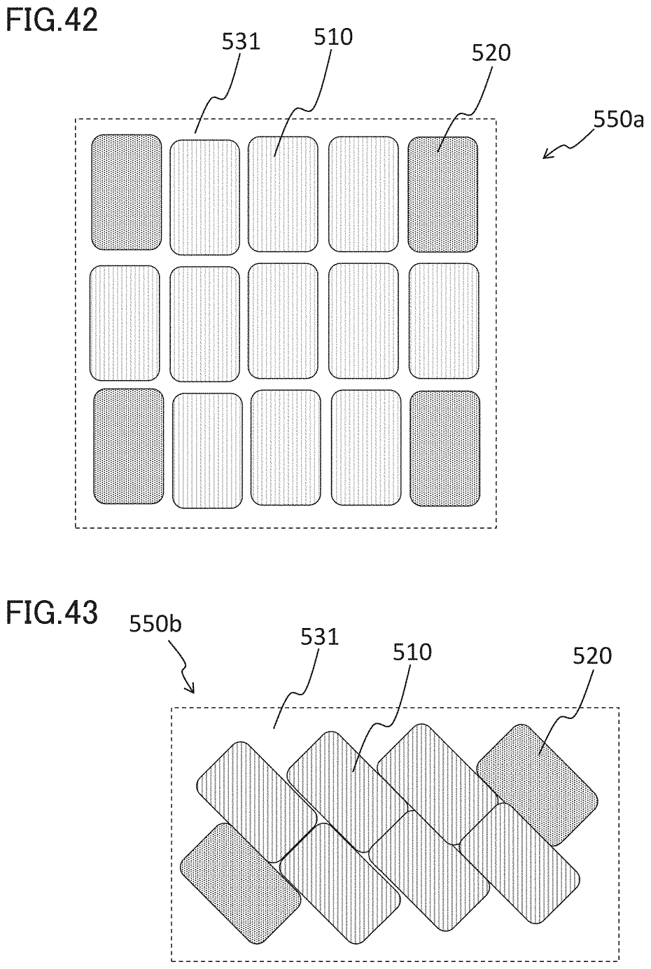

Note that when the proportion of the second sushi pieces 520 is low, each of the second sushi pieces 520 may be positioned in a corner (a corresponding one of the four corners) of the tray 531 of the frozen sushi pack 550 illustrated in FIG. 42. When a frozen sushi pack is defrosted, the edges of the container are likely to be heated. In particular, the four corners of the tray receive an electric field of a high intensity, and are likely to be heated. Hence, the second sushi pieces 520 fewer than the first sushi pieces 510 are each arranged in one of the four corners, making it possible to reduce uneven heat distribution among all the sushi pieces.

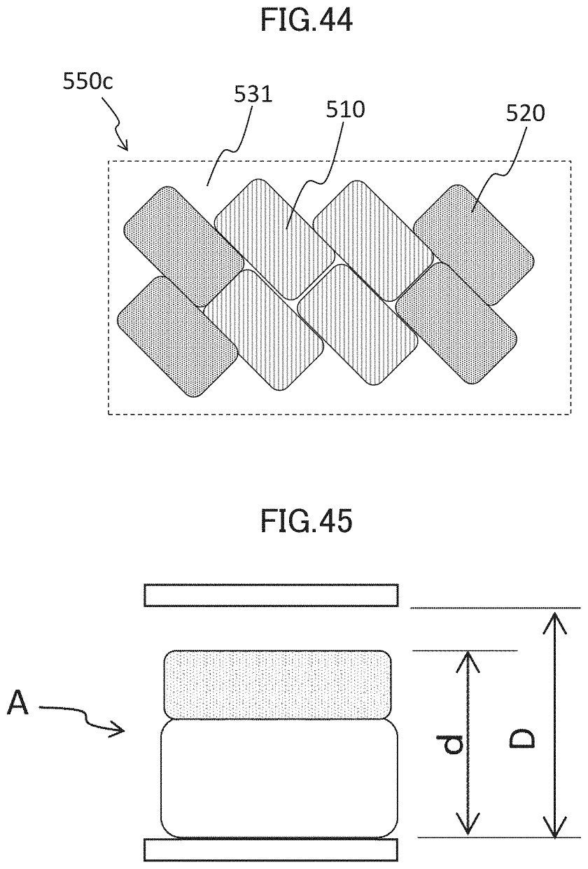

Another example of the arrangement of the second sushi pieces 520 in the corners of the tray 531 includes an arrangement in a frozen sushi pack 550b illustrated in FIG. 43 and in a frozen sushi pack 550c illustrated in FIG. 44. In the example illustrated in FIG. 43, the sushi pieces are arranged at angle to the shape of the tray 531 when viewed from above, and the short second sushi pieces 520 are each positioned to the top right and the bottom left in the drawing. The frozen sushi pack 550c illustrated in FIG. 44 shows an example of arranging the sushi pieces at angle to the shape of the tray 531 when the number of the first sushi pieces 510 is the same as that of the second sushi pieces 520. The sushi pieces arranged at angle remind consumers of an assortment of high-end sushi presented in a sophisticated manner. Moreover, the short sushi pieces less likely to be heated are arranged in an area likely to be heated, making it possible to reduce uneven heat distribution among all the sushi pieces.

Note that, when all the sushi pieces are arranged in close contact with one another, a portion other than the edges (e.g., a center of a chunk of the six tall first sushi pieces 510 in FIG. 43) is less likely to be heated no matter how the sushi pieces are carefully arranged. Such an arrangement can be a cause of uneven heat distribution among all the sushi pieces. Hence, in the arrangement, the sushi pieces are spaced apart from one another so that an electric field can concentrate on the edge of each sushi piece. Such an arrangement reduces the risk of uneven temperature distribution among all the sushi pieces.

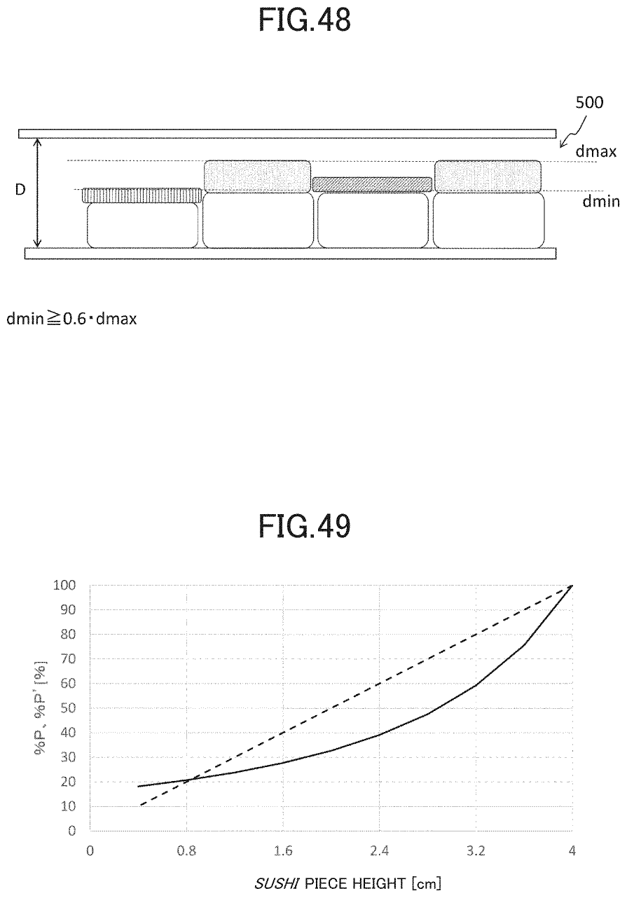

How to Adjust Height of Sushi Piece Described next is how to adjust a height of a plurality of sushi pieces included in the frozen sushi packs 500 and 550. Among the sushi pieces in the frozen sushi packs 500 and 550 according to this embodiment, a height dmin of the shortest sushi piece is 60% or greater than a height dmax of the tallest sushi piece (see FIG. 48).

As to the definition of a sushi piece, described below is a verification experiment conducted by the inventors of the present invention.

In the verification experiment by the inventors, the frozen sushi pack 500 was dielectrically heated with a defroster whose inter-electrode distance D is 5 cm. The frozen sushi pack 500 contained a total of nine sushi pieces 510 and 520 including a battleship “gunkan-maki” roll as the tallest (dmax=4 cm) piece and a squid nigiri-zushi piece as the shortest (dmin=2.5 cm) piece. The results show that all the sushi pieces were successfully defrosted without uneven temperature distribution.

Here, the height (dmin=2.5 cm) of the squid nigiri-zushi piece is approximately 60% (62.5%) of the height (dmax=4 cm) of the battleship “gunkan-maki” roll.

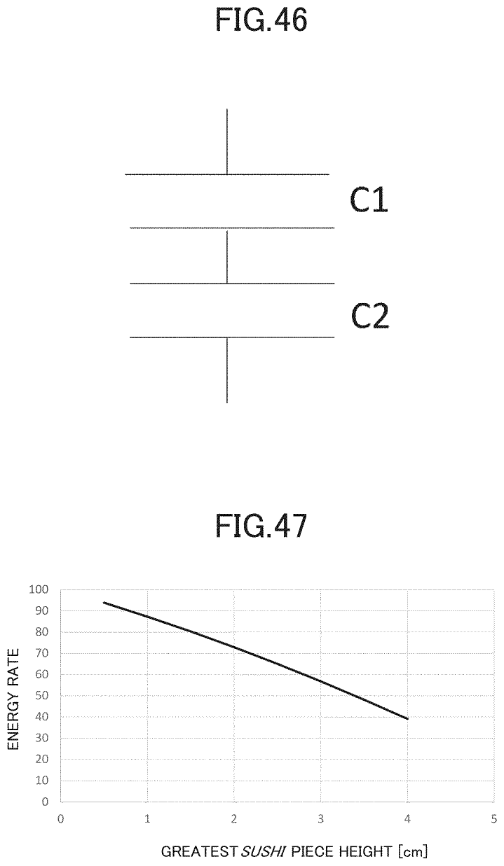

Obtained here is an energy rate per unit area of a sushi piece in the evaluation experiment. As illustrated in FIG. 45, “D” and “d” respectively represent an inter-electrode distance and a height of a product A to be heated (i.e., a sushi piece) in the verification experiment. Moreover, when the illustration in FIG. 45 is shown as an equivalent circuit in FIG. 46, C represents a capacitance of a space area and C2 represents a capacitance of a sushi piece.

First, V(d) is represented by expressions below where the inter-electrode distance is 1 and V(d) represents a voltage to be applied to the product A with the height d:

$$\begin{matrix}V ( d ) = C 1 / ( C 1 + C 2 ) \\ = \{ {ɛ}_{0} \cdot S / ( D - d ) \} / [ {ɛ}_{0} \cdot S \cdot \{ 1 / ( D - d ) + {ɛ}_{r} / d \} ] \\ = d / \{ d + {ɛ}_{r} \cdot ( D - d ) \} ,\end{matrix} \qquad$$

where

S: an area of a sushi piece observed from the above, and

εᵣ: the relative permittivity (ice: 4).

Hence, a field strength E(d) inside the product A is represented by an expression (A) below:

$$\begin{matrix}E ( d ) = V ( d ) / d \\ = 1 / \{ d + {ɛ}_{r} \cdot ( D - d ) \}\end{matrix} \qquad ( A )$$

An energy per unit area inside the field intensity E(d) is commonly represented by an expression below:

P(d)=K·εᵣ·tan δ·f·E(d)², where
K: the constant 0.556×10¹⁰,
tan δ: the dissipation factor, and
f: the frequency

An energy inside a sushi piece can be obtained by an expression (B) below if εᵣ, tan δ, and f are constants:

P(d)=K′·E(d)² (B)

Next, using the expressions (A) and (B), defined is a rate of energy per unit area of a sushi piece with a height d2 to energy per unit area of a sushi piece with a height d1:

$$\begin{matrix}\% P ( D , d 1 , d 2 ) = P ( d 2 ) / P ( d 1 ) \cdot 100 \\ = {[ \{ d 1 + {ɛ}_{r} \cdot ( D - d 1 ) \} / \{ d 2 + {ɛ}_{r} \cdot ( D - d 2 ) \} ]}^{2} \cdot 100\end{matrix} \qquad ( C )$$

When the inter-electrode distance D=5 cm, the height of the tallest sushi piece d1=dmax=4 cm, and the height of the shortest sushi piece d2=dmin=2.4 cm (60% of 4 cm) are substituted in the expression (C), the rate of energy is approximately 40% as obtained below:

% P(5,4,2.4)=39.1

That is, when the rate of energy per unit area inside the sushi piece is 40% or above, the frozen sushi pack can be defrosted, reducing the risk of uneven heating.

FIG. 47 is a graph illustrating the expression (C) in which D=5 cm, d1=dmax=0.5 to 4 cm, and d2=dmin=0.6·dmax (60% of dmax) are substituted.

In the frozen sushi pack 500 (the illustration of the container is omitted) including sushi pieces having a different height as illustrated in FIG. 48, if the greatest sushi piece height dmax is 4 cm or smaller (e.g., 3 cm), and the smallest sushi piece height dmin is 60% of the greatest sushi piece height dmax or greater, (e.g., 60% of 3 cm, namely 1.8 cm), the rate of energy per unit area inside the sushi piece is 40% or above. Hence, the frozen sushi pack can reduce the risk of uneven heating in defrosting.

Note that, taking into consideration the shape of the tray 531 of, and a distance of the space between the cover 532 and a neta topping in, the container 530, a practical height of a sushi piece can be smaller than 80% of the inter-electrode distance. That is, when the inter-electrode distance D is 5 cm, the greatest height of the container 530 of the frozen sushi pack 500 can be 5 cm. Among the sushi pieces to be arranged in the container 530, the tallest sushi piece is usually 4 cm or shorter.

When the smallest sushi piece height, which is 60% of the greatest sushi piece height, is substituted in the expression (C) if the greatest sushi piece height is 4 cm or greater, the rate of energy per unit area inside the sushi piece is 40% or below. However, taking into consideration the shape of the tray of, and a distance of the space between the cover and a neta topping in, the container, a practical height of a sushi piece can be 4 cm or shorter, that is, smaller than 80% of the inter-electrode distance D. In such a case, the rate of energy cannot be smaller than 40%, and, practically, the lowest difference in height between the sushi pieces may be 60%.

As can be seen, among the sushi pieces in the frozen sushi pack, the height dmin of the shortest sushi piece is 60% or greater than the height dmax of the tallest sushi piece, making it possible to reduce the risk of uneven heating caused by difference in height between the sushi pieces. In the frozen sushi packs 500 and 550 according to this embodiment, the sushi pieces with a different height are arranged more freely. Moreover, while a condition of dmin≥0.6·dmax is satisfied, the sushi pieces are arranged as seen in the arrangement examples described in this embodiment, making it possible to further reduce the risk of uneven heating in defrosting.

Relationship Between Height and Proportion of Water of Sushi Piece

Described next is a relationship between a height and a proportion of water of the sushi pieces included in the frozen sushi packs 500 and 550.

As can be seen, other than the height, a water content of sushi pieces also affects how well the sushi pieces in a frozen sushi pack are heated in defrosting. That is, if a proportion of water between the sushi pieces is small, the sushi pieces are theoretically less likely to be heated unevenly in defrosting even though a difference in height between the sushi pieces is great.

Hence, for example, the shari rice base of a tall sushi piece is prepared to contain a slightly larger proportion of water, and the shari rice base of a short sushi piece is prepared to contain a slightly smaller proportion of water. That is, preferably, the neta toppings 511 of the first sushi pieces 510 classified into the first group are prepared larger in water content per unit volume than the neta toppings 521 of the second sushi pieces 520 classified into the second group. Moreover, alternatively, a proportion of water contained in a shari rice base may also vary, reflecting a proportion of water depending on a kind of a neta topping. Such features make it possible to reduce the risk of uneven heating of a frozen sushi pack in defrosting.

Here, the sushi pieces, included in the frozen sushi pack 500, each have the height d and the proportion of water B (a water content per unit volume). In each of the sushi pieces, when C is a rate of the proportion of water B to the height d, Cmin, the smallest rate C, is preferably 60% of, or above, Cmax, the largest rate C.

When dH and BH are respectively a height and a proportion of water of a tall sushi piece, and dL and BL are respectively a height and a proportion of water of a short sushi piece, an expression (D) is preferably satisfied to successfully defrost a frozen sushi pack while avoiding uneven heating:

[{P(dL)/BL}/{P(dH)/BH}]100=% P(D,dH,dL)·(BH/BL)≥40 (D)

In producing a frozen sushi pack to be defrosted with its quality maintained, however, it is troublesome to actually refer to the expression (D). Hence, the solid line of FIG. 49 indicating % P(D, dH, dL) is substituted for a proportional straight line passing through the origin and representing a rate of a height of a sushi piece to energy inside the sushi piece, as illustrated by the broken line indicating % P′. Hence, the expression (D) is simplified to an expression (E) below:

% P′·(BH/BL)=(dL/dH)·(BH/BL)·100 (E)

When the proportions of water BL and BH are equal among the sushi pieces, both of the relationships below hold:

BH/BL=1,and

(dL/dH)·100≥60

Hence, an expression (F) is derived:

$$\begin{matrix}\% {P}^{′} \cdot ( BH / BL ) = ( d L / dH ) \cdot ( BH / BL ) \cdot 100 \\ = ( d L / BL ) / ( d H / BH ) \cdot 100 \geq 60\end{matrix} \qquad ( F )$$

Here, when (dL/BL) and (dH/BH) are respectively replaced with Cmin and Cmax, an expression (G) below is obtained:

Cmin/Cmax≥60 (G)

When the height and the proportion of water of sushi pieces are adjusted to satisfy the expression (G), the sushi pieces can be arranged more freely in view of reducing the risk of heating unevenness due to the difference in height among the sushi pieces.

Relationship Between Height and Mass Density of Sushi Piece

Described next is a relationship between a height and a mass density of the sushi pieces included in the frozen sushi packs 500 and 550.

As can be seen, other than the height, a water content of sushi pieces also affects how well the sushi pieces in a frozen sushi pack are heated in defrosting. It could be difficult, however, to measure an actual proportion of water for each sushi piece. Hence, a mass density, which is correlated to the proportion of water, can also be used as an indicator of how well the sushi pieces are heated in defrosting.

Here, the sushi pieces, included in the frozen sushi pack 500, each have the height d and a mass density G (a mass (g/cm³) per unit volume). In each of the sushi pieces, when H is a rate of the mass density G to the height d (i.e., G/d), Hmin, the smallest rate H, is preferably 60% of, or above, Hmax, the largest rate H.

When dH and GH are respectively a height and a mass density of a tall sushi piece, and dL and GL are respectively a height and a mass density of a short sushi piece, an expression (H) below is preferably satisfied to successfully defrost a frozen sushi pack while avoiding uneven heating:

$$\begin{matrix}\% {P}^{′} \cdot ( GH / GL ) = ( d L / dH ) \cdot ( GH / GL ) \cdot 100 \\ = ( d L / GL ) / ( dH / GH ) \cdot 100 \geq 60\end{matrix} \qquad ( H )$$

Here, when (dL/GL) and (dH/GH) are respectively replaced with Hmin and Hmax, an expression (I) below is obtained:

Hmin/Hmax≥60 (I)

When the height and the mass density (g/cm³) of sushi pieces are adjusted to satisfy the expression (I), the sushi pieces can be arranged more freely in view of reducing heating unevenness due to the difference in height among the sushi pieces.

Method for Defrosting Frozen Sushi Pack

Described next is a method for defrosting the frozen sushi pack 500 according to this embodiment. Note that this method can be applicable to the frozen sushi packs 500a and 550 other than the frozen sushi pack 500.

In a similar manner to the frozen sushi pack 400 according to the fifth embodiment, the frozen sushi pack 500 can be defrosted in accordance with the defrosting step of the method for producing a food product described in the above fourth embodiment. When defrosted, the frozen sushi pack 500 is dielectrically heated with a high-frequency electric field of HF waves or VHF waves. This defrosting method may be carried out with, for example, such a defroster as the high-frequency heating apparatus 100 described in the first embodiment, or the high-frequency heating apparatus 200 described in the second embodiment. Specifically, the frozen sushi pack 500 (a product to be defrosted) is sandwiched between the upper electrode 1a and the lower electrode 1b, and a high-frequency electric field of HF waves or VHF waves is applied between the electrodes to dielectrically heat the frozen sushi pack 500.

In defrosting the frozen sushi pack 400, a quick defrosting technique is preferably selected to finish the defrosting in the shortest time period possible. A typical technique for quick defrosting involves heating with microwaves of a microwave oven. This technique, however, could cause excessive and uneven heating, and the frozen food product cannot be defrosted with its quality maintained high. Meanwhile, the defrosting with an electric field of VHF waves or HF waves from the above high-frequency heating apparatuses reduces the risks of excessive and uneven heating, and draining juice, making it possible to defrost the food product with its quality maintained high.

Described here is an example of the dielectric heating apparatus to be used in defrosting the frozen sushi pack 500. As can be seen, the defrosting may be carried out with, for example, the high-frequency heating apparatus 100 or the high-frequency heating apparatus 200 described as an example of the dielectric heating apparatus according to the present invention.

Each of the high-frequency heating apparatuses 100 and 200 includes: at least a pair of electrodes facing each other (i.e., the upper electrode 1a and the lower electrode 1b); the high-frequency power supply 2 supplying a high-frequency electric field of HF waves or VHF waves; and the matching circuit 3.

Such a feature makes it possible to efficiently apply the high-frequency electric field to the frozen sushi pack 500, that is, the feature can quickly provide high-quality sushi whose temperature distribution is less likely to be uneven.

Moreover, the dielectric heating apparatus to be used in the defrosting may further include a position changing mechanism changing positions of the electrodes. An example of the position changing mechanism includes the movable unit 8 of the high-frequency heating apparatus 100.

The movable unit 8 can change the position of the upper electrode 1a in dielectric heating in accordance with the size of the frozen sushi pack 500. When the distance between the upper electrode 1a and a frozen food product is appropriately set, energy can be efficiently provided to the frozen food product, and the product can be defrosted in a short time period.

The embodiments disclosed herewith are examples in all respects, and shall not be interpreted to be limitative. The scope of the present invention is intended to be disclosed not in the above embodiments, but in the claims. All the modifications equivalent to the features of, and within the scope of, the claims are to be included within the scope of the present invention. Furthermore, features recited in different embodiments described in this Description are combined to obtain another feature. Such a feature shall be included within the scope of the present invention.

### REFERENCE SIGNS LIST

1a: Upper Electrode (Electrode Plate)
1b: Lower Electrode (Electrode Plate)
2: High-Frequency Power Supply
3: Matching Circuit
3a: Variable Capacitor (Variable Reactance Element)
3b: Variable Capacitor (Variable Reactance Element)
4: Reader (Determiner)
5: Memory (Storage Unit)
6: Control Circuit (Controller)
7: Operation Unit (Input Unit)
8: Movable Unit (Position Changing Mechanism)
100: High-Frequency Heating Apparatus (Dielectric Heating Apparatus)
200: High-Frequency Heating Apparatus (Dielectric Heating Apparatus)
300: Frozen Sushi Piece (Frozen Food Product)
301: Neta Topping (Upper Layer)
302: Shari Rice Base (Lower Layer)
400: Frozen Sushi Pack (Frozen Sushi Set)
410: First Sushi Piece
411: Neta Topping
412: Shari Rice Base
420: Second Sushi Piece
421: Neta Topping
422: Shari Rice Base
430: Container
431: Tray
500: Frozen Sushi Pack (Frozen Sushi Set)
510: First Sushi Piece
511: Neta Topping
512: Shari Rice Base
520: Second Sushi Piece
521: Neta Topping
522: Shari Rice Base
530: Container
531: Tray

1. A frozen sushi set, comprising:
a container; and
a plurality of sushi pieces arranged in the container, wherein
each of the sushi pieces includes: a shari rice base; and a neta topping, and
using a water content per unit volume ranging from 55% to 65% as a reference value, the sushi pieces are classified into:
a first group in which the neta topping contains a water content below the reference value; and
a second group in which the neta topping contains a water content equal to the reference value or above.

2. The frozen sushi set according to claim 1, wherein
the sushi pieces classified into the second group are arranged closer to an end of the container.

3. The frozen sushi set according to claim 1, wherein
the neta topping includes at least two kinds of neta toppings each having a different water content per unit volume,
the at least two kinds of neta toppings include: a first neta topping a water content per unit volume of which is low; and a second neta topping a water content per unit volume of which is high, and
when a front-rear direction and a left-right direction of the frozen sushi set in a horizontal plane are defined, second sushi pieces each having the second neta topping are arranged next to first sushi pieces each having the first neta topping, while the second sushi pieces are positioned in at least two of four neighboring positions including front, rear, left, and right of each of the first sushi pieces, the first sushi pieces and the second sushi pieces being included in the sushi pieces.

4. The frozen sushi set according to claim 1, wherein
the sushi pieces classified into the first group and the sushi pieces classified into the second group are alternately arranged in the container.

5. The frozen sushi set according to claim 1, wherein
the sushi pieces classified into the first group account for 25% to 75% of all the sushi pieces included in the frozen sushi set.

6. The frozen sushi set according to claim 1, wherein
the neta topping for each of the sushi pieces classified into the first group is larger in amount than the neta topping for each of the sushi pieces classified into the second group.

7. The frozen sushi set according to claim 6, wherein
the neta topping for each of the sushi pieces classified into the first group is taller than the neta topping for each of the sushi pieces classified into the second group.

8. The frozen sushi set according to claim 1, wherein
the frozen sushi set is defrosted by dielectric heating with a high-frequency electric field of HF waves or VHF waves.
